(19) United States
(12) Patent Application Publication
(10) Pub. No.: US 2025/0220114 A1
(43) Pub. Date: Jul. 3, 2025

(54) Content-Independent Dropped Call Detection

(71) Applicant: CX360, Inc., Omaha, NE (US)

(72) Inventors: Heather Lourie, Omaha, NE (US); Patrick M. Peterson, Omaha, NE (US)

(21) Appl. No.: 18/401,174

(22) Filed: Dec. 29, 2023

(51) Int. Cl. H04M 3/493; G10L 15/02; G10L 15/06; G10L 15/18; G10L 25/93

(52) U.S. Cl. CPC H04M 3/493; G10L 15/02; G10L 15/063; G10L 15/18; G10L 25/93

(57) ABSTRACT

A computer-implemented method of providing content-independent detection of dropped customer service calls to an interactive platform, including receiving a batch of recorded calls for analysis, the recorded calls comprising recorded audio of customer service calls from a human user to the interactive platform, and call metadata for the recorded calls; featurizing the recorded calls into per-call feature vectors, comprising extracting features that are independent of content of the recorded calls; using a machine learning (ML) device to detect dropped calls based on the per-call feature vectors; providing the dropped calls to a human analyst; receiving, from the human analyst, a recommendation to improve the interactive platform based on the dropped calls; and implementing the recommendation on the interactive platform.

### FIELD OF THE SPECIFICATION

This application relates in general to machine learning, and more particularly though not exclusively to a system and method for content-independent dropped call detection.

### BACKGROUND

In a customer service center, dropped calls may represent lost opportunities and customer dissatisfaction.

### BRIEF DESCRIPTION OF THE DRAWINGS

The present disclosure is best understood from the following detailed description when read with the accompanying FIGURES. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion. Furthermore, the various block diagrams illustrated herein disclose only one illustrative arrangement of logical elements. Those elements may be rearranged in different configurations, and elements shown in one block may, in appropriate circumstances, be moved to a different block or configuration.

FIG. 1 is a block diagram of selected elements of an IVR ecosystem.

FIG. 2 is a block diagram of selected elements of a call analysis platform.

FIG. 3 is a block diagram illustration of selected elements of processing call recordings.

FIG. 4 is a block diagram illustration of selected elements of a user interface.

FIG. 5 is a block diagram illustration of selected elements of a feature extractor.

FIG. 6 is a block diagram illustration of selected elements of a model training architecture.

FIG. 7 is a block diagram illustration of selected elements of a system analysis ecosystem.

FIG. 8 is a flow chart illustrated selected elements of a method of detecting and acting on dropped calls.

FIG. 9 is a block diagram of selected elements of a hardware platform.

FIG. 10 is a block diagram of selected elements of a network function virtualization (NFV) infrastructure.

FIG. 11 is a block diagram of selected elements of a containerization infrastructure.

FIG. 12 illustrates machine learning according to a “textbook” problem with real-world applications.

FIG. 13 is a flowchart of a method that may be used to train a neural network.

### SUMMARY

A computer-implemented method of providing content-independent detection of dropped customer service calls to an interactive platform, including receiving a batch of recorded calls for analysis, the recorded calls comprising recorded audio of customer service calls from a human user to the interactive platform, and call metadata for the recorded calls; featurizing the recorded calls into per-call feature vectors, comprising extracting features that are independent of content of the recorded calls; using a machine learning (ML) device to detect dropped calls based on the per-call feature vectors; providing the dropped calls to a human analyst; receiving, from the human analyst, a recommendation to improve the interactive platform based on the dropped calls; and implementing the recommendation on the interactive platform.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

### Overview

An interactive voice platform (IVP) is an example of an interactive technology that may be used, for example, to drive a customer service function. The IVP may receive queries or prompts from a human user, and may respond by attempting to infer an intent, which may correlate to a customer service function. If the IVP functions correctly, it infers the user's intent, and connects the user to the appropriate customer service function that corresponds to the intent. For example, if the user has a billing question, then the IVP should connect the user to an appropriate customer service center that handles billing questions. It may also gather information from the user so that it can pre-populate information to a customer service agent (CSA) who will handle the call. In some cases, the customer service center may provide an automated function that can handle the user's customer service request autonomously. For example, if the user wants to order a product, then an automated system may collect the appropriate billing information, the product to be ordered, and other relevant information such as a shipping address. In those cases, a human CSA may not be necessary to carry out the customer service function.

In general terms, success for an IVP may represent an instance where the call ends with the user or caller having been connected to the appropriate service function, and with the user feeling satisfied that his concerns were addressed and that the desired intent was resolved. To carry out such functions, IVPs may include interactive voice response (IVR) systems, which have been available for years. IVRs may have somewhat limited and scripted functionality to respond to a limited number of prompts. Newer systems may include interactive voice assistance (IVA), which may provide more flexible voice prompts and more sophisticated back ends, including machine learning (ML) models. Whether for an IVA, an IVR, or some other IVP, the high level goal may be similar. The system is to infers the user's intent, and connect the user to an appropriate customer service function. Furthermore, nonvoice systems, such as textual chatbots have also become popular, and serve a similar function.

A failure mode for an IVP may occur when the IVP does not connect the human user to the appropriateness service function, for example where the IVP connects the user to the wrong service function, or is unable to infer an intent, and instead needs to involve a human CSA. Involving a human CSA increases costs and reduces efficiency, and thus is less preferred in at least some systems. Another failure mode may occur when the call is prematurely terminated. Premature termination may occur, for example, if the caller becomes frustrated and gives up on the call and simply hangs up. Premature termination may also occur if the call is accidentally dropped by either party, if a call transfer fails, if the telephone carrier drops the call, or if the call otherwise ends unexpectedly. In the context of the present specification and the appended claims, a call that ends prematurely is referred to as a “dropped call,” regardless of the reason the call was dropped. Dropped calls can, in some cases, be either a symptom or a cause of user dissatisfaction. Thus it may be a goal of a customer service center to minimize dropped calls. When a call is dropped, the negative impact on both the customer and the agent can be substantial in terms of wasted time and lost reputation. Thus, for an enterprise that intends to improve an IVP system (“a user experience service provider”), identifying and diagnosing dropped calls can provide substantive recommendations for improvements.

However, when the service provider is analyzing a large batch of hundreds or thousands of calls, it may not be practical for a human user to listen to all of the calls to determine which ones dropped prematurely. Thus an automated call analytics system may be used to highlight dropped call events, assuming those events can be detected automatically. The present specification discloses a system and method for detecting dropped calls, which can then be reviewed by a human analyst to identify root causes and otherwise improve the system. Note that the call analytics system need not analyze or understand why the call was dropped to be effective. In at least some cases, the human analyst is tasked with understanding what led to the call being dropped, and determining remedial actions that may reduce dropped calls in the future. Thus, for the automated system, merely identifying and tagging or highlighting the dropped calls may be sufficient to benefit the human analyst. This can reduce the number of calls needing to be reviewed from thousands or hundreds to tens or ones of calls, with high probability that the tagged calls genuinely represent dropped calls.

Because each call has a definite terminal or endpoint, it is straightforward for the call analytics system to determine that a call ended (because all calls eventually end), and when a call ended (the call disconnected, and the recording stopped). However, to identify dropped calls, the system may need to make some inferences about whether the call ended prematurely, e.g., before the caller received a satisfactory resolution to his customer service need. If the call ended after the service request was satisfactorily resolved, then the call may represent a success mode. On the other hand, dropped calls represent one of several failure modes for customer service calls.

As one data source, a telephone carrier (e.g., land line or cellular carrier) may provide telephony system events, such as the calling party number, the called number, the call time, call duration, which party terminated the call, and whether error codes were encountered. Within the context of the IVP, the system may divide the call into a plurality of channels, such as a caller channel and a call center channel. The caller channel may represent audio signals originating from the caller or user. The call center channel may represent audio signals originating from the call center. Within each channel, the system may detect events by channel, such as touch tones, recorded prompts, natural language word patterns, agent greetings, hold music, or other similar information. The system may also use a speech-to-text engine to generate transcripts of each call, and tokenize each channel into a sequence of utterances. In one example, utterances are tokenized by silence lasting more than a threshold time, which may be on the order of several hundred milliseconds. Because the utterance detection is separated by channel, there need not be silence between the caller and the call center to generate a new token. However, any silence within a single channel will be tokenized (e.g., the call center speaking, and the caller responding, may represent two distinct utterances, even if there is little or no silence between them). The utterances can be marked with information such as duration, start time, end time, and channel identity.

In embodiments of the present specification, it may not be necessary to substantively analyze the content of the utterances to perform, for example, sentiment analysis to attempt to determine the callers or the CSA's state of mind when the call terminated. Rather, according to the system and method of the present specification, patterns in timing of events and other features of the call can be used to accurately identify dropped calls with a high confidence, and particularly with a sufficiently high confidence to provide useful analysis data for a human expert. Detection of these time patterns may be based on any appropriate mechanism, such as a finite state machine automaton, with specified rules driven by the sequence of events. In another example, a neural network or other machine learning (ML) model trained on the event sequences of many calls that have been annotated with disconnects or dropped calls to determine whether a dropped call happened.

Thus advantageously, the system of the present specification may not require highly-accurate transcripts to identify dropped calls. In one example, the only analysis of content of utterances includes classifying the utterances into a small number of high-level classes, such as detecting that a specific utterance represents the initial greeting from a human CSA. Without needing detailed content, the system may operate on the number of words, the duration of utterances, the time between utterances, and other temporal data to detect dropped calls. This may provide advantages because even though the content of speech of both callers and call-center agents during the call can be helpful in detecting dropped calls, the content of the speech may be highly variable. Thus, to train a model based on content of speech may require a much larger sample size to capture that variability, as well as the input of language experts to correct call transcripts for training. While larger data sets require more time and compute resources, they also present another challenge in that dropped calls are relatively infrequent compared to the whole set of calls recorded in a call center, and thus it may be difficult to glean a sufficiently large set of dropped calls to adequately train an ML model on the content of dropped calls. By using a simpler feature set, without requiring accurate transcription, the system of the present specification may perform as well, or nearly as well, as a model trained on a larger content set, while requiring a much smaller training set. Thus the resulting language-independent dropped call detector may be much simpler and less expensive than a larger and more complex content-aware model.

The system may also decrease dependence on regional language variances. Because speech patterns are different between languages and cultures, there may be some need to retrain models for specific regions, languages, or cultures. A language-independent model may require fewer language skills to annotate calls as dropped or not.

### Selected Examples

The foregoing can be used to build or embody several example implementations, according to the teachings of the present specification. Some example implementations are included here as nonlimiting illustrations of these teachings.

There is disclosed an example of a computer-implemented method of providing content-independent detection of dropped customer service calls to an interactive platform, comprising: receiving a batch of recorded calls for analysis, the recorded calls comprising recorded audio of customer service calls from a human user to the interactive platform, and call metadata for the recorded calls; featurizing the recorded calls into per-call feature vectors, comprising extracting features that are independent of content of the recorded calls; using a machine learning (ML) device to detect dropped calls based on the per-call feature vectors; providing the dropped calls to a human analyst; receiving, from the human analyst, a recommendation to improve the interactive platform based on the dropped calls; and implementing the recommendation on the interactive platform.

There is further disclosed an example, wherein the interactive platform is an interactive voice platform (IVP).

There is further disclosed an example, wherein the call metadata comprise metadata from a telephone carrier.

There is further disclosed an example, wherein featurizing the recorded calls comprises separating the recorded calls into channels.

There is further disclosed an example, wherein the channels comprise a caller channel and a call center channel.

There is further disclosed an example, wherein featurizing the recorded calls further comprises tokenizing the recorded calls into discrete utterances based on per-channel silence.

There is further disclosed an example, wherein featurizing the calls comprises classifying non-speech utterances on only one channel.

There is further disclosed an example, wherein featurizing the recorded calls comprises tokenizing the recorded calls into discrete utterances based on silence.

There is further disclosed an example, wherein featurizing the recorded calls comprises classifying non-speech utterances.

There is further disclosed an example, wherein featurizing the recorded calls comprises classifying some speech utterances into one or more high-level classes based on content.

There is further disclosed an example, wherein the one or more high-level classes are the only features based on language content.

There is further disclosed an example, wherein the one or more high-level classes comprise an operator greeting.

There is further disclosed an example, further comprising training the ML model on a large set of recorded calls with dropped calls tagged.

There is further disclosed an example, wherein featurizing the recorded calls comprises extracting, from the recorded calls, features channel, termination, uttlen, speechbinary, timedife, eaminsc, and lastagentstime.

There is further disclosed an example, wherein featurizing the recorded calls comprises extracting, from the recorded calls, at least two features selected from a list consisting of channel, termination, uttlen, speechbinary, timedife, eaminsc, lastagentstime, lastagentetime, lastcalleretime, lastcallerstime, ecminsa, scminae, timedifs, timedife, list(range(0,300), timedifs, and samince.

There is further disclosed an example, further comprising excluding, from the list, at least two features that are highly statistically coordinated with one another.

There is further disclosed an example of an apparatus comprising means for performing the method.

There is further disclosed an example, wherein the means for performing the method comprise a processor and a memory.

There is further disclosed an example, wherein the memory comprises machine-readable instructions that, when executed, cause the apparatus to perform the method.

There is further disclosed an example, wherein the apparatus is a computing system.

There is further disclosed an example of at least one computer readable medium comprising instructions that, when executed, implement a method or realize an apparatus as described.

There is further disclosed an example of one or more tangible, nontransitory computer-readable storage media having stored thereon executable instructions to: receive a batch of recorded calls for analysis, the recorded calls comprising recorded audio of customer service calls from a human user to an interactive voice platform (IVP), and call metadata for the recorded calls; featurize the recorded calls into per-call feature vectors, comprising extracting features that are independent of verbal content of the recorded calls; provide a detection software module to detect dropped calls based on the per-call feature vectors; provide the dropped calls to a human analyst; receive, from the human analyst, a recommendation to improve the IVP based on the dropped calls; and implement the recommendation on the IVP.

There is further disclosed an example, wherein the detection software module includes a machine learning (ML) routine.

There is further disclosed an example, wherein the detection software module includes a finite state machine.

There is further disclosed an example, wherein the call metadata comprise metadata from a telephone carrier.

There is further disclosed an example, wherein featurizing the recorded calls comprises separating the recorded calls into channels.

There is further disclosed an example, wherein the channels comprise a caller channel and a call center channel.

There is further disclosed an example, wherein featurizing the recorded calls further comprises tokenizing the recorded calls into discrete utterances based on per-channel silence.

There is further disclosed an example, wherein featurizing the calls comprises classifying non-speech utterances on only one channel.

There is further disclosed an example, wherein featurizing the recorded calls comprises tokenizing the recorded calls into discrete utterances based on silence.

There is further disclosed an example, wherein featurizing the recorded calls comprises classifying non-speech utterances.

There is further disclosed an example, wherein featurizing the recorded calls comprises classifying some speech utterances into one or more high-level classes based on content.

There is further disclosed an example, wherein the one or more high-level classes are the only features based on language content.

There is further disclosed an example, wherein the one or more high-level classes comprise an operator greeting.

There is further disclosed an example, wherein the instructions are further to train the ML model on a large set of recorded calls with dropped calls tagged.

There is further disclosed an example, wherein featurizing the recorded calls comprises extracting, from the recorded calls, features channel, termination, uttlen, speechbinary, timedife, eaminsc, and lastagentstime.

There is further disclosed an example, wherein featurizing the recorded calls comprises extracting, from the recorded calls, at least two features selected from a list consisting of channel, termination, uttlen, speechbinary, timedife, eaminsc, lastagentstime, lastagentetime, lastcalleretime, lastcallerstime, ecminsa, scminae, timedifs, timedife, list(range(0,300), timedifs, and samince.

There is further disclosed an example, wherein the instructions are further to exclude, from the list, at least two features that are highly statistically coordinated with one another.

There is further disclosed an example of a computing apparatus, comprising: a hardware platform comprising a processor circuit and a memory; and instructions encoded within the hardware platform to instruct the processor circuit to: receive a batch of recorded calls for analysis, the recorded calls comprising recorded audio of customer service calls from a human user to an interactive voice platform (IVP), and call metadata for the recorded calls; featurize the recorded calls into per-call feature vectors, comprising extracting features that are independent of verbal content of the recorded calls; provide a detection software module to detect dropped calls based on the per-call feature vectors; provide the dropped calls to a human analyst; receive, from the human analyst, a recommendation to improve the IVP based on the dropped calls; and implement the recommendation on the IVP.

There is further disclosed an example, further comprising a virtualization infrastructure.

There is further disclosed an example, further comprising a containerization infrastructure.

There is further disclosed an example, wherein the detection software module includes a machine learning (ML) routine.

There is further disclosed an example, wherein the detection software module includes a finite state machine.

There is further disclosed an example, wherein the call metadata comprise metadata from a telephone carrier.

There is further disclosed an example, wherein featurizing the recorded calls comprises separating the recorded calls into channels.

There is further disclosed an example, wherein the channels comprise a caller channel and a call center channel.

There is further disclosed an example, wherein featurizing the recorded calls further comprises tokenizing the recorded calls into discrete utterances based on per-channel silence.

There is further disclosed an example, wherein featurizing the calls comprises classifying non-speech utterances on only one channel.

There is further disclosed an example, wherein featurizing the recorded calls comprises tokenizing the recorded calls into discrete utterances based on silence.

There is further disclosed an example, wherein featurizing the recorded calls comprises classifying non-speech utterances.

There is further disclosed an example, wherein featurizing the recorded calls comprises classifying some speech utterances into one or more high-level classes based on content.

There is further disclosed an example, wherein the one or more high-level classes are the only features based on language content.

There is further disclosed an example, wherein the one or more high-level classes comprise an operator greeting.

There is further disclosed an example, wherein the instructions are further to train the ML model on a large set of recorded calls with dropped calls tagged.

There is further disclosed an example, wherein featurizing the recorded calls comprises extracting, from the recorded calls, features channel, termination, uttlen, speechbinary, timedife, eaminsc, and lastagentstime.

There is further disclosed an example, wherein featurizing the recorded calls comprises extracting, from the recorded calls, at least two features selected from a list consisting of channel, termination, uttlen, speechbinary, timedife, eaminsc, lastagentstime, lastagentetime, lastcalleretime, lastcallerstime, ecminsa, scminae, timedifs, timedife, list(range(0,300), timedifs, and samince.

There is further disclosed an example, wherein the instructions are further to exclude, from the list, at least two features that are highly statistically coordinated with one another.

### DETAILED DESCRIPTION OF THE DRAWINGS

A system and method for content independent dropped call detection will now be described with more particular reference to the attached FIGURES. It should be noted that throughout the FIGURES, certain reference numerals may be repeated to indicate that a particular device or block is referenced multiple times across several FIGURES. In other cases, similar elements may be given new numbers in different FIGURES. Neither of these practices is intended to require a particular relationship between the various embodiments disclosed. In certain examples, a genus or class of elements may be referred to by a reference numeral (“widget 10”), while individual species or examples of the element may be referred to by a hyphenated numeral (“first specific widget 10-1” and “second specific widget 10-2”).

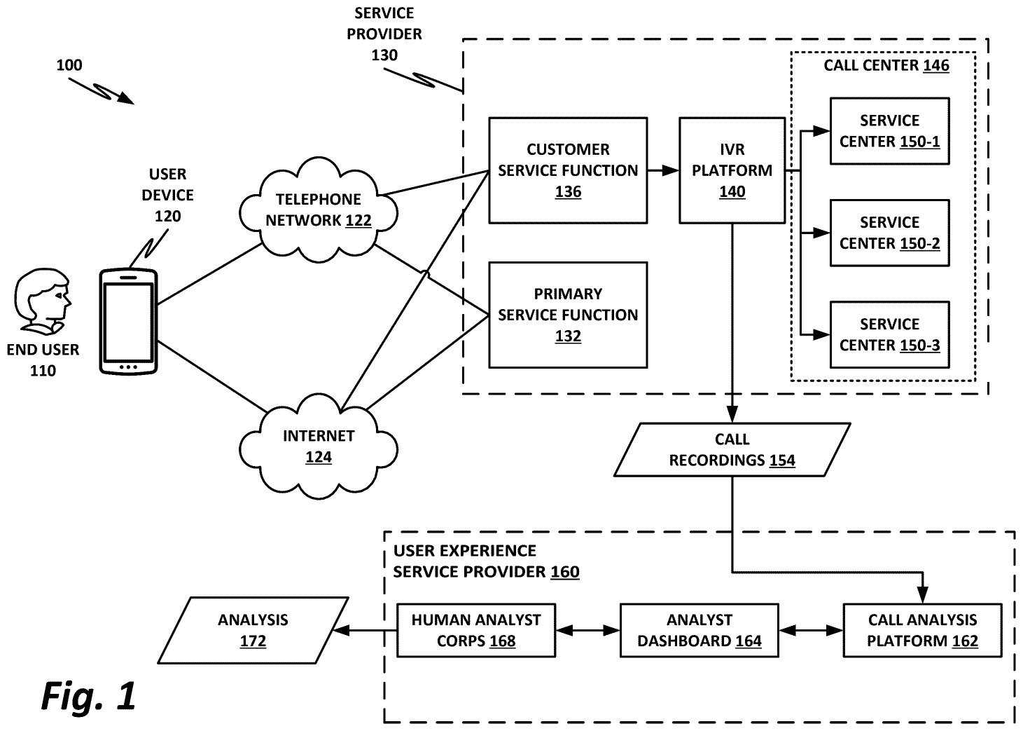

FIG. 1 is a block diagram of selected elements of an IVR ecosystem 100. IVR ecosystem 100, in this illustration, includes three major players, namely an end user 110, a service provider 130, and a user experience service provider 160. Service provider 130 provides a primary service function 132 to end user 110. For example, service provider 130 may be a phone company, a bank, a cellular provider, an e-commerce provider, or other service provider that may benefit from an IVR. An IVR is used in this FIGURE as an illustrative example, but other embodiments are also disclosed, such as an interactive voice assistant (IVA), which is generally more advanced than an IVR, a chatbot, or other interactive function. As a class, these may be referred to as interactive voice platforms (IVP).

Primary service function 132 includes the substantive service that service provider 130 provides to end users 110. For example, if service provider 130 is a mobile phone service, then its primary service function is providing mobile telephony to its customers.

In support of the primary service function 132, service provider 130 may also include a customer service function 136. Customer service function 136 may be an auxiliary to primary service function 132, and may handle customer questions, complaints, service requests, and other support functions. Customer service function 136 may operate an IVR platform 140. End user 110 may access customer service function 136 using a user device 120, such as a cell phone or landline phone, via telephone network 122, which may be a cellular network, a digital network, voiceover IP, public switched telephone network (PSTN), or other appropriate network.

In an illustrative service example, end user 110 operates user device 120 to call service provider 130 via telephone network 122. Service provider 130 connects user device 120 to customer service function 136. Customer service function 136 accesses IVR platform 140, which may include a number of automated prompts in a natural language processing (NLP) engine, a large language model (LLM), a prompt tree, or other logic that attempts to connect the user to the appropriate service or resource.

A call center 146 may include a plurality of service centers 150-1, 150-2, and 150-3, for example. One function of IVR platform 140 is to timely connect end user 110 to an appropriate service center 150 to handle the issue or concern presented by end user 110. Service centers 150 may include one or both of human customer service agents and electronic resources.

In addition to a voice telephone network 122, end user 110 may use device 120 to access internet 124, which may connect end user 110 to both primary service function 132 and customer service function 136. Modern customer service centers often include a chatbot or other electronic version of the IVR. The chatbot may perform a similar function to that of the IVR and may have prompts and a decision tree or other logic to attempt to route user 110 to the appropriate service center 150. In general terms, a successful customer service interaction may be defined as one in which user 110 is timely routed to the appropriate service center 150, and the service center 150 is able to resolve the customer's concern or issue to the customer's satisfaction. An unsuccessful customer service interaction is one in which the customer becomes frustrated, angry, or one in which the concern is not resolved to the customer's satisfaction. Furthermore, even if customer service function 136 successfully resolves end user 110's concern, if the resolution is not timely, then the customer may nevertheless feel unsatisfied, which represents, at best, a partial success for customer service function 136.

Thus, it may be a goal of IVR platform 140 to timely connect end user 110 to an appropriate service center 150 in such a way that end user 110's issue or concern is timely and satisfactorily resolved.

To provide more and better service interactions, service provider 130 may contract with user experience service provider 160 to improve IVR platform 140. For example, it is common to inform users of an IVR system that their calls may be recorded for training and quality assurance. When those calls are recorded, a large batch of call recordings 154 can be sent to user experience service provider 160. User experience service provider 160 may operate a call analysis platform 162, which may include a database of known IVR prompts, derived either automatically or via human intervention, or a combination of the two. Call analysis platform 162 may analyze and tag calls by recognizing IVR prompts, tagging them with timestamps, and associating them with a taxonomic identification that a human analyst can use to assess the value and success of given prompts.

An analyst dashboard 164 may include one or more computing systems that provide a user interface, such as a GUI, that a human analyst corps 168 can use to analyze IVR calls to determine their success and effectiveness. The human analyst corps 168 can then provide feedback to the service provider 130, in the form of analysis and recommendations 172, which service provider 130 can use to improve IVR platform 140.

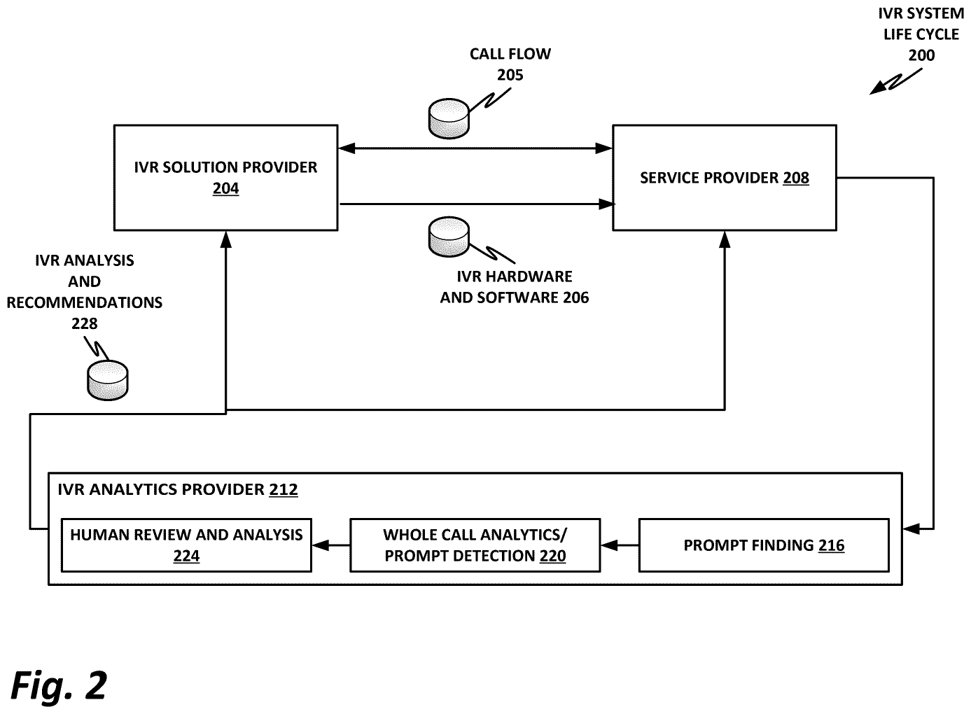

FIG. 2 is a block diagram of selected elements of an IVR system lifecycle 200. IVR system lifecycle 200 illustrates interactions between an IVR solution provider 204, a service provider 208, and an IVR analytics provider 212.

IVR solution provider 204 is the original vendor of hardware and software to provide a comprehensive IVR solution to service provider 208. IVR solution provider 204 provides the initial programming and setup of the IVR system hardware and software. IVR solution provider 204 may work closely with service provider 208 to identify call flows 205. Call flows 205 may include a call tree, or they may include training data for a more flexible interactive voice system. Once IVR solution provider 204 has the appropriate call flows 205, it may program the IVR system and deliver IVR hardware and software 206 to service provider 208.

Service provider 208 purchases and operates the IVR system as part of its customer service function, and operates the IVR system for a time to provide services to its customers.

After some use of the IVR system, service provider 208 may wish to improve IVR hardware and/or software 206 for example, to ensure that end users have a better customer service experience. To this end, service provider 208 may contract with an IVR analytics provider 212. IVR analytics provider 212 may be the same enterprise as IVR solution provider 208, or may be a completely separate enterprise.

IVR analytics provider 212 provides analysis of the IVR system. This includes a pipeline that provides, for example, prompt finding 216, whole call analytics and prompt detection 220, and human review and analysis 224. Certain aspects of the present disclosure are particularly concerned with prompt finding 216. Prompt finding may include identifying prompts from call recordings. Whole call analytics may include, among other things, detecting dropped calls. Review and analysis 224 may include, among other things, determining root causes of dropped calls, and determining how to reduce the number of dropped calls.

IVR analytics provider 212 may provide analysis and recommendations 228, which in appropriate circumstances may be provided to service provider 208 and/or to IVR solution provider 204 to improve the IVR system.

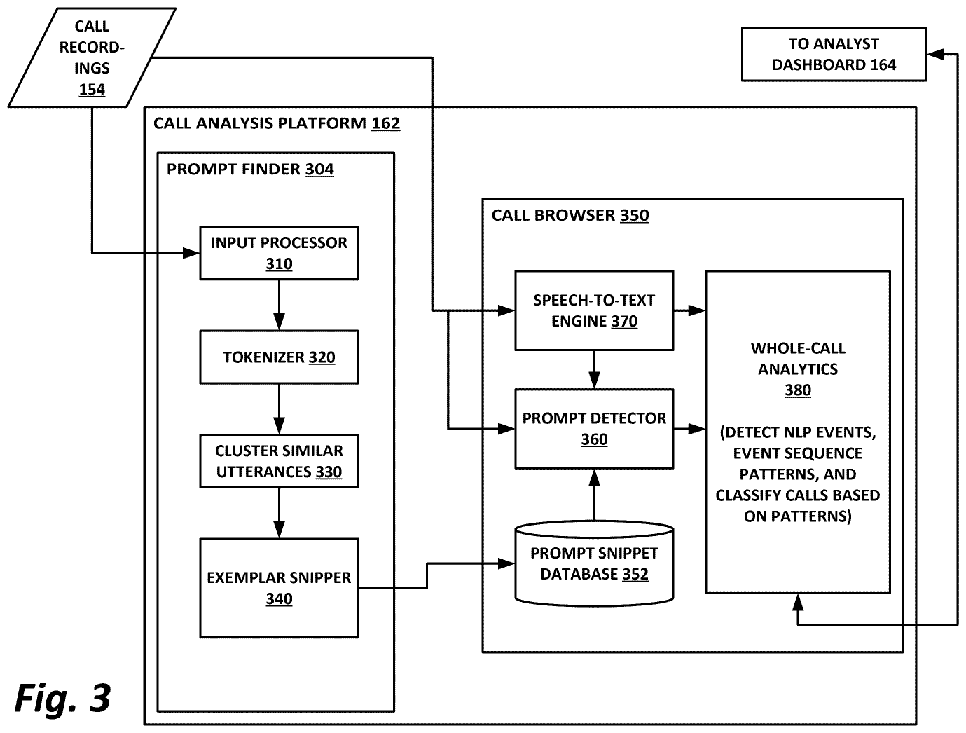

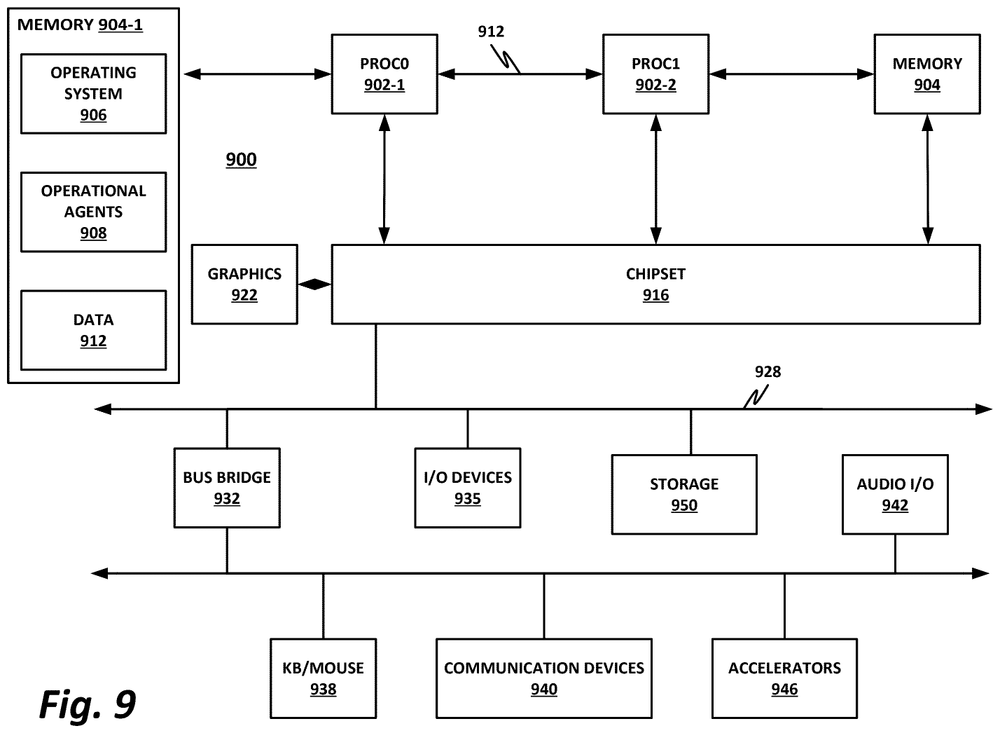

FIG. 3 is a block diagram of selected elements of a call analysis platform 162. Call analysis platform 162 may run on one or more hardware platforms, for example as illustrated in FIG. 9 below.

Call analysis platform 162 includes a prompt finder 304 and a call browser 350. Prompt finding may form a valuable part of featurizing recorded calls, because the timing between prompts and other events may be a substantial feature. Furthermore, in some cases, the content of prompts may be characterized, such as into high-level classes, as an additional feature.

Prompt finder 304 may include hardware and software elements to identify clusters of similar prompts, including designating a representative snippet (exemplar) for each cluster. As discussed above, the system and method disclosed herein can substantially streamline the process of prompt finding, for example reducing the lead time from weeks to days or hours. Call browser 350 may facilitate prompt detection, in which calls are analyzed to detect and tag known prompts that match to an exemplar. Calls that have been tagged in call browser 350 can then be provided to an analyst dashboard 164, where a human or AI analyst can assess the effectiveness of calls and provide recommendations for improvement of the IVR system.

Prompt finder 304 may include an input processor 310, which receives an input batch for analysis. The input batch may include a large number of call recordings 154 for analysis.

Input processor 310 may include a tokenizer 320, which may include hardware or software to identify discrete utterances within the call. An utterance may be defined, for example, as an instance of speech after a period of silence, such as 100 milliseconds, which period may be configurable. Furthermore, tokenizer 320 may identify utterances by detecting different tones, pitch, speech patterns, or similar. For example, the computerized IVR recordings may have different pitch, tone, and speech patterns than non-IVR-voice sources of audio in the IVR channel.

Tokenization may also occur in cases where speech-to-text processing is used in prompt finding. In that case, tokenized utterances may be divided into discrete text units, which can be compared more quickly, and with fewer compute resources, than can audio snippets.

Tokenizer 320 may provide discrete utterances to clustering module 330, which may include hardware or software elements to identify similar utterances that are to be grouped together (such as utterances that appear to be the same or a similar IVR prompt). Clustering may include identifying audible similarity (for example, via a DSP), or textual similarity (for example, via text comparison after text-to-speech conversion). Clustering module 330 may include a frequency model, which determines how frequently certain utterances occur throughout the call set. Utterances that occur more frequently may be more likely to be IVR prompts, because a computer is more likely to repeat substantially exact phrases than a human.

Once prompt candidates have been clustered, exemplar snipper 340 snips a short, representative audio segment that can be used to identify other instances of the same prompt. The snippet may, for example, be taken from the beginning of the utterance sample, and may comprise a short audio snippet of less than one second, or more particularly of approximately 800 milliseconds.

In the case of speech-to-text processing, instead of cutting a representative audio snippet, exemplar snipper 340 may take a short, representative sample of text. This may be the text that corresponds to the portion that would be snipped for an audio sample (e.g., 800 milliseconds), but it may be longer or shorter. Because text comparison is faster and lighter on compute resources than audio comparison, the text sample may be longer. Furthermore, because speech-to-text transcription is not always exact, the comparison may be a fuzzy comparison or may use NLP algorithms that recognize similar text, even if they do not match exactly.

Prompt finder 304 may provide representative prompt snippets to call browser 350, which may store the prompt snippets in a prompt snippet database 352, which may also associate with the prompt snippet metadata, such as taxonomic designations of prompt snippets (if the prompts are in a prompt tree), or other identifying information that may be used to uniquely identify each prompt and its role in the IVR system.

Extracted snippets can be used to automatically tag calls that flow into the call browser, where analysts examine calls and provide analysis and recommendations.

Call browser 350 may include a speech-to-text engine 370, which provides a machine-generated transcript of the call. Although such transcripts are not always consistent with the intended speech, they provide enough information to be useful for call analysis.

A prompt detector 360 accesses prompt snippet database 352, which has short snippets that were identified by prompt finder 304. Prompt detector 360 may scan the set of calls for instances of the identified prompt snippets, and may then designate the full utterance associated with the snippet as a prompt. Prompt detector 360 may also tag the utterance with the prompt metadata. In some cases, detection and tagging may be a joint human/machine operation, wherein the computer provides initial tagging, and human operators may correct the detection as necessary.

Prompt detector 360 may also use text transcripts from speech-to-text engine 370 to find prompts within calls. Text matching may be based on exact text matching, regular expressions, fuzzy matching, and/or NLP in appropriate embodiments. Prompt detector 360 provides detected prompts to whole-call analytics module 380. Whole-call analytics module may also receive text transcripts from speech-to-text engine 370. With calls tagged with the appropriate prompts, and with text transcripts, whole-call analytics module 380 may perform additional analysis on each call. This may include, for example, detecting NLP events, detecting event sequences and patterns, and classifying calls based on patterns. As with other blocks, in at least some embodiments, this may include cooperative machine-human efforts.

For example, whole-call analytics module 380 may select prompts from prompt snippets database 352 to reduce selected calls for analysis into a tree of IVR prompts. In some analysis regimens, human utterances are less important than identifying the tree logic that the IVR prompts follow and identifying the overall results of the call. However, human utterances may be useful in analyzing human responses or sentiments (e.g., some IVR systems, instead of using DTMF, use voice recognition and ask a user to say a number or ask a particular question), in which case human utterances may be useful for matching those utterances to the correct IVR response to determine whether the IVR correctly routed the call or correctly followed the tree based on the human utterances. Sentiment may also be useful in assessing a user's happiness, stress level, or irritation, which may also be useful inputs to the IVR analysis.

An output of whole-call analytics engine 380 may be a set of calls that are appropriately classified, tagged, and marked with prompts. The system may provide these calls to analyst dashboard 164.

A success model may be available to human analysts to determine which calls are successful and which are less successful. One important aspect of identifying call success is providing human analysts with a call browser that has calls tagged with the correct timestamps of IVR prompts and the correct taxonomy assigned to each identified prompt. Based on the success model, human analysts or an automated system may provide feedback, which is returned to the IVR solution provider to help improve the IVR.

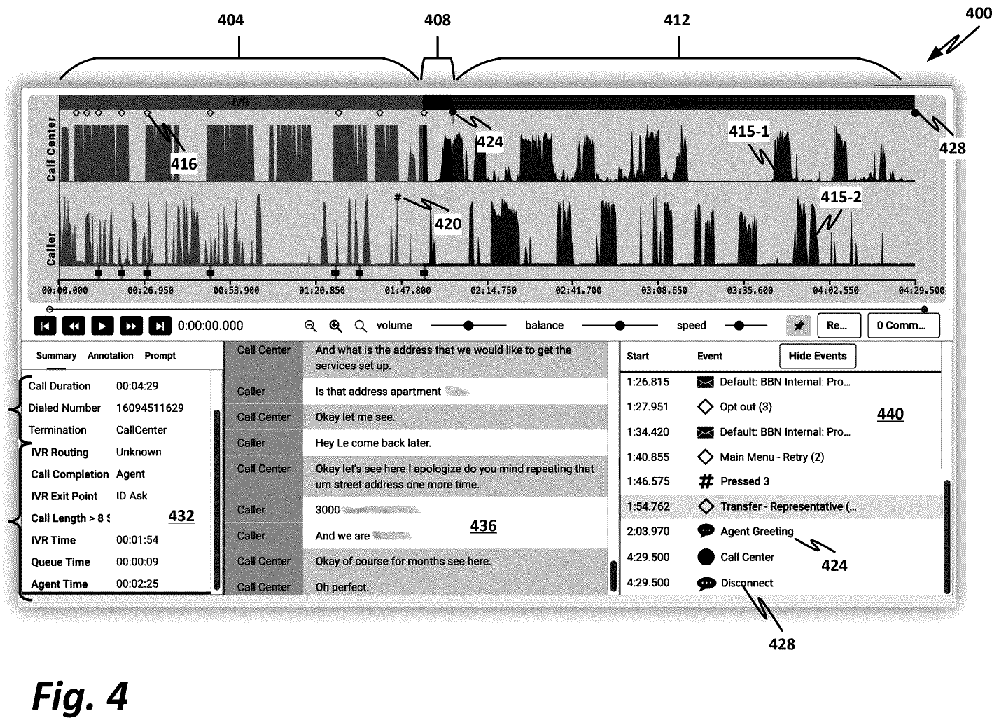

FIG. 4 is a block diagram illustration of a user interface 400 that a human call analyst may use to evaluate a specific call. The this may be, for example, an illustration of or a part of analyst dashboard 164 of FIG. 1. In this example, call analysis platform 162 may have already analyzed the call, identified prompts, identified timestamps, divided the audio into channels, provided transcript, and populated metadata with the call.

User interface 400 provides useful contextual data for the analyst to review along with the call. For example, the call is visually divided into three segments, including an IVR segment 404, representing the time during which the human caller was interacting with the IVR or another automated IVP. At approximately 1:50 (one minute, 50 seconds), the IVR had either determined the appropriate customer service center to direct the user to, or had determined that it was unable to answer the question and that the caller would need to speak to a human operator. Thus, for a short time (approximately 9 seconds), represented as queue segment 408, the caller was on hold with the customer service center. After a few seconds, a human CSA answered the phone, and the remainder of the conversation is represented by agent segment 412.

The audible interactions may be divided into a plurality of utterances, illustrated here as utterance 415-1 and utterance 415-2. Utterances may be delimited by periods of silence as is visibly apparent from the waveforms illustrated within call window 400. It is also visible here that the call has been divided into two discrete audio channels, namely a caller channel and a call center channel. Note that although there is little to no silence between utterance 415-1 and utterance 415-2, these are treated as two discrete utterances because they occur on different channels.

Call window 400 is also annotated with useful symbols to illustrate portions of the call. For example a diamond symbol represents IVR prompts as illustrated by prompt 416. A touchtone (such as when the caller uses a numeric keypad to select a menu option) is represented by touchtone 420. Speech events are represented by a speech bubble as in speech event 424. Call events (such as call disconnect) are represented by call events 428.

Call browser 400 also includes useful information such as a summary window 432, which provides a summary of data. Some of the data in summary window 432 may be provided by the telephony carrier, such as the number dialed, the call duration, and where (caller side or call center side) the call was terminated. Here, the human analysts can see that the call lasted for total of 4:29 (four minutes, 29 seconds). The call had an IVR entry point of “ID Ask,” and was ultimately transferred to a human agent. The caller spoke with the human agent for 2:25 (two minutes and 25 seconds), while the caller interacted with the IVR system for 1:54 (one minute and 54 seconds). The caller was on hold in the queue for nine seconds.

Importantly, the human analyst can also see that the call was terminated by the call center. This is also visible in event list 440, in which certain key events are timestamped for the human analyst. Again, the human analyst can see important events such as an agent greeting at 2:03, and a disconnect at 4:29.5, with the disconnect event coming from the call center.

Within transcript window 436, the human analyst can see a transcript of the call. Because this transcript is machine generated, it may not be completely accurate, but it may provide sufficient information to aid in the analysis. In this instance, the human analyst can review discrete utterances divided by caller and call center turns in the conversation. Even with some apparent errors in the transcription, it is evident from transcript 436 that the call center agent is setting up services for the caller. After getting the caller to repeat his or her address, the agent says “oh perfect,” and appears to be working on something, but then the line goes dead on the call center side.

This dropped call may represent a waste of time for both the caller and the CSA. Furthermore, the dropped call may represent a loss of reputation for the service provider, if the human caller is dissatisfied with the dropped call, and may represent a lost sale if the user does not call back to try again to order service.

If a human expert reviews this call, she may be able to provide valuable insight into why the call was dropped, and recommendations to improve the system to avoid dropped calls in the future. From the data provided, the human analyst may be able to determine that the dropped call was a technology issue. The caller was still interacting with the human CSA, and (at least before the call dropped) does not appear to have been dissatisfied with the customer service experience. Thus, the analyst's recommendations to the IVP provider may include technological improvements, whereas in the case of a call terminated by a frustrated caller, her recommendations may be focused on better training for CSAs or improvements to the IVA model.

However, to provide the analysis, the human analyst needs to find this call in the first place. One nontrivial task is to segregate this dropped call from a large volume of recorded calls from the call center. Because dropped calls are relatively uncommon occurrences, it may be a substantial time burden for a human analyst to review every call to determine whether it was dropped or not. Furthermore, while a machine learning model may be trained on the transcript to use a content-aware method of identifying dropped calls, such methods may be highly dependent on locale and language training, and may require substantial hardware and software resources. Furthermore, it may be difficult to adequately train such a system because the volume of available dropped calls for training may not be large enough to train the model with sufficient variety.

Advantageously, the system and method of the present specification provides a machine learning model that can be trained on features other than the content of transcript 436. For example, the machine learning model may use features available in summary window 432 and event list 440 to infer that this call represents a dropped call. These features may be wholly or mostly agnostic of the content of the transcript. Thus, there may be sufficient data to adequately train the ML model with those features, because there may be less variability in those features than there is in common human speech patterns. Furthermore, because the model may be smaller and less complex than a content-aware model, it may run on reduced hardware, and for less expense.

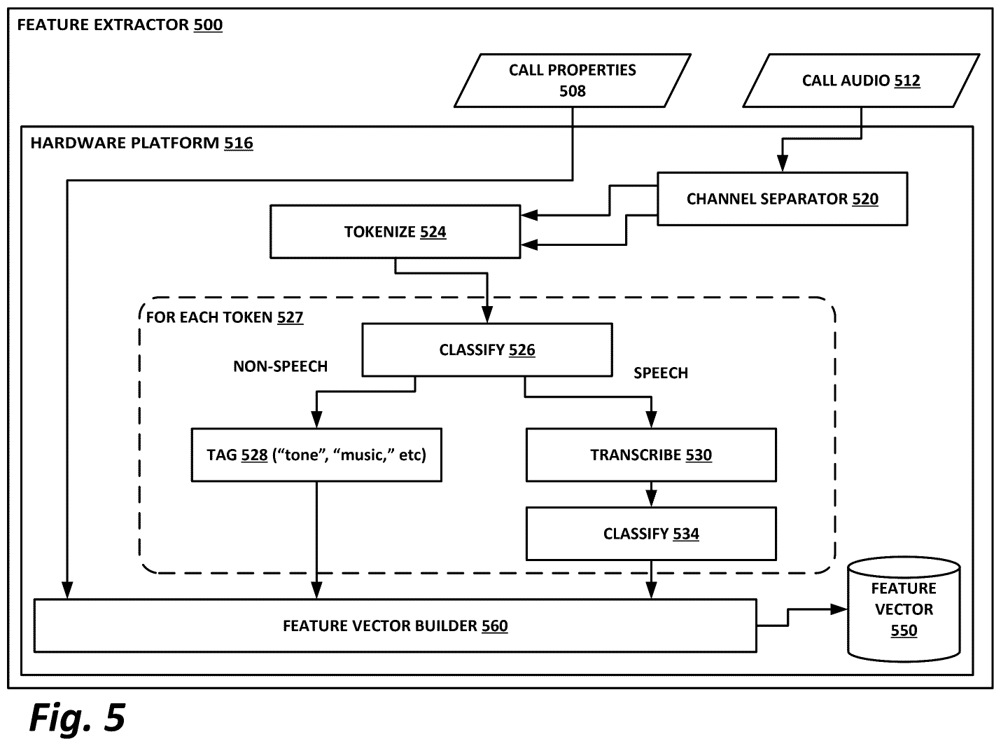

FIG. 5 is a block diagram of selected elements of a feature extractor 500. Feature extractor 500 may receive call audio 512, and call properties 508. In this illustrated example, feature extractor 500 is illustrated operating on a single call, while it should be understood that in a broader deployment, feature extractor 500 will be run many times to analyze a large number of calls in a similar way. Furthermore, multiple instances of feature extractor 500 may be run in parallel to analyze multiple calls at once.

In this case, call audio 512 may be an audio recording of the call, while call properties 508 may include metadata about the call. Call properties may include data available from the carrier or telephony provider, such as automatic number identification (ANI), dialed number identification service (DNIS), which party terminated the call, whether there is a termination code or error code (e.g., indicating that the issue may have occurred with the carrier), or other information. Feature extractor 500 may provide information based on features extracted from the telephony data and other call properties 508, along with call audio 512.

A channel separator 520 receives call audio 512, and may separate the audio sample into a plurality of channels, such as two channels. These two channels may represent a channel for the caller and a channel for the call center.

A tokenizer block 524 may then tokenize the audio segments for each channel, such as by splitting audio segments on periods of silence greater than a threshold (e.g., a few hundred milliseconds). Tokenizer 524 provides a plurality of tokens from each audio channel of the call.

In block 527, each tokenized audio segment (utterance) is then classified, per block 526, as either speech or nonspeech utterances. Nonspeech utterances, for example, may be data such as tones, music, background noise, or other categories. Utterances be tagged with channel and timing properties.

In block 528, nonspeech audio segments are associated with their inferred tags.

For speech segments, in block 530 a speech-to-text engine may transcribe the audio, which may be later presented to a human operator for analysis.

In block 534, based on the transcripts, the featurizer may classify at least some utterances into a high-level classification. Note that this classification need not include detailed sentiment analysis or other complex modeling. In one illustrative example, where the content data are classified, the data are used simply to identify certain audio segment whose timing may be significant, such as a greeting from the CSA. Classifier 534 may also optionally classify segments such as questions, answers, agent greetings, or other.

A feature vector builder 560 receives call properties 508, tagged nonspeech elements 528, and classified audio segments 534, to build a feature vector 550 for the call. The feature vector may include certain features that are useful for identifying dropped calls.

In one illustrative example, features may include the following:
channel: whether utterance was from caller or agent channel
termination: did caller or agent terminate the call?
uttlen: number of words in utterance
speechbinary: 1 for speech, 0 for music or silence or tone
timedife: difference between the end times of the last caller utterance and last agent utterance
eaminsc: difference between last agent end time and last caller start time
lastagentstime: start time of the last agent utterance
lastagentetime: end time of the last agent utterance
lastcalleretime: end time of the last caller utterance
lastcallerstime: start time of the last caller utterance
ecminsa: caller end time minus agent start time
scminae: caller start time minus agent end time
timedifs: difference between start of last utterance and end of call
timedife: difference between end of last utterance and end of call
list(range(0,300): the average of the utterance word embeddings from a dictionary of 300-dimensional word vectors
timedifs: the difference between the start times of the last caller utterance and last agent utterance
samince: difference between agent start time and caller end time

Not all of these features need to be used in every embodiment. For example, statistical analysis may reveal that some features in the list are highly correlated with one another. Highly-correlated features may be functionally redundant in predicting whether a call represents a dropped call. Thus, among a set of highly-correlated features, only one may be necessary to use for prediction. Additional statistical analysis, as well as trial and error analysis, can be used to identify a reduced set of features to use for prediction.

In one illustrative embodiment, the features used to train and predict dropped calls include:
channel: whether utterance was from caller or agent channel
termination: did caller or agent terminate the call?
uttlen: number of words in utterance
speechbinary: 1 for speech, 0 for music or silence or tone
timedife: difference between the end times of the last caller utterance and last agent utterance
eaminsc: difference between last agent end time and last caller start time
lastagentstime: start time of the last agent utterance

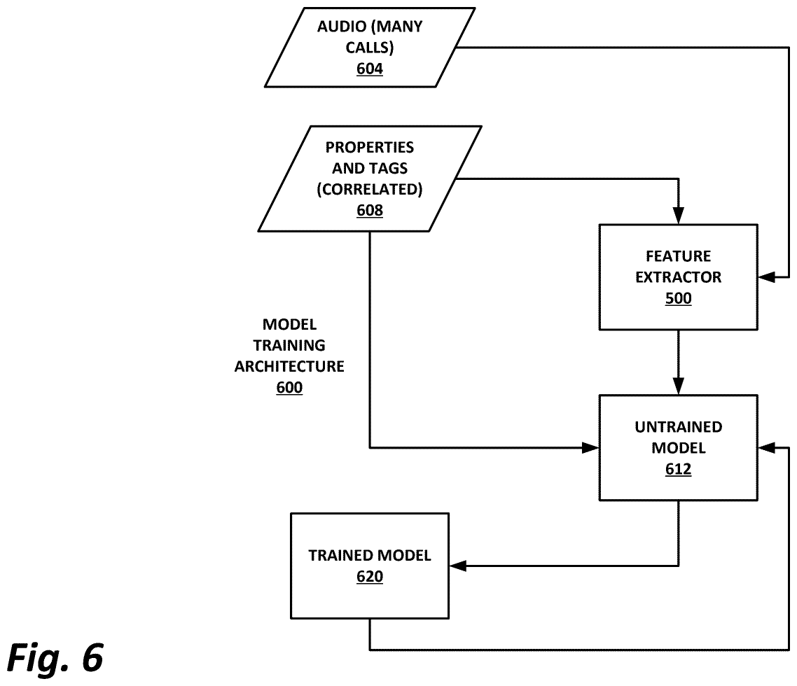

FIG. 6 is a block diagram of a model training architecture 600. Model training architecture 600 receives recorded call audio for a large set of calls 604, which may include hundreds or thousands of recorded calls from a customer service center. In this specification and the appended claims, a “large” set includes at least 100 examples. Model training architecture 600 also receives properties and tags 608, which are correlated to the audio recordings in block 604. The properties and tags 608 are a training data set, which may include not only the properties illustrated in FIG. 5 for example, but also may include a set of known dropped calls, with the dropped calls being annotated. These annotations can be used to train an untrained model 612.

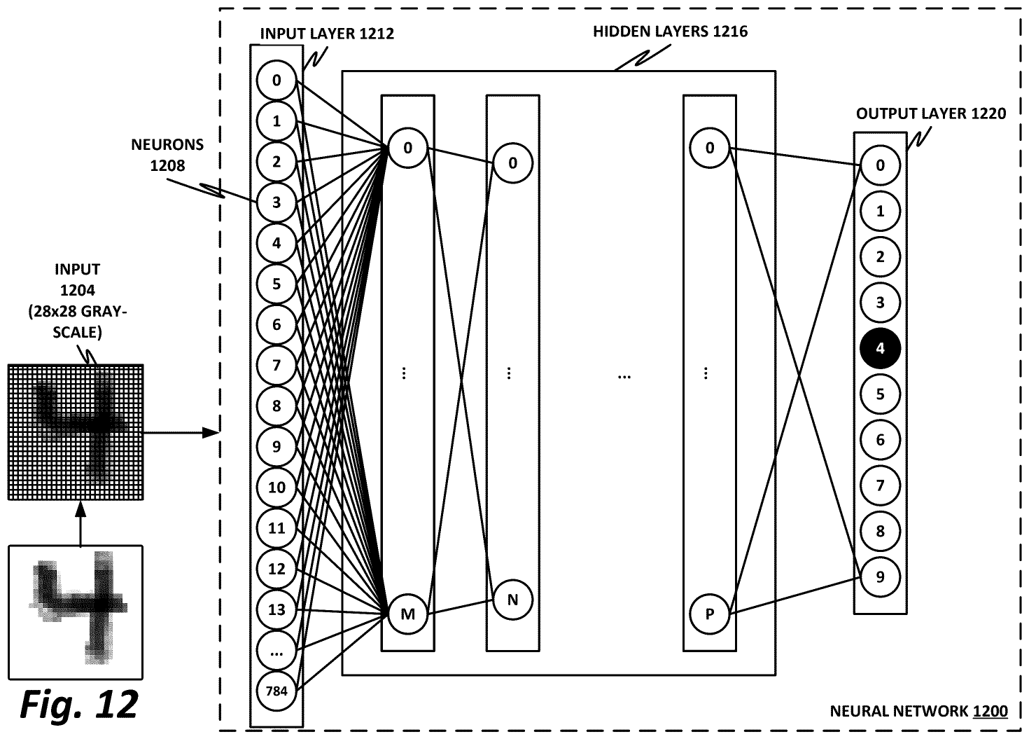

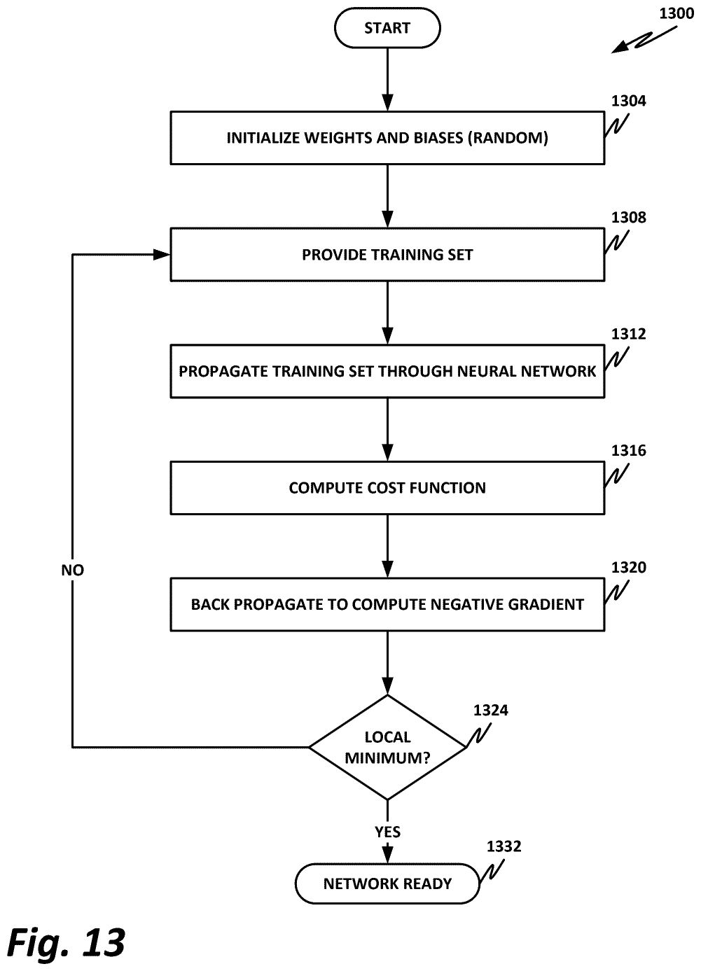

A feature extractor 500 receives audio 604 and properties and tags 608, and performs feature extraction as illustrated in FIG. 5. The featurized calls are then provided to untrained model 612, which can then be trained to recognize the known set of dropped calls using known ML training techniques. Some principles and architecture related to operating an ML are illustrated in FIGS. 12 and 13 below, which should be viewed as nonlimiting examples of foundational principles.

Once untrained model 612 has been trained on a sufficient number of known dropped calls, it may be deployed as trained model 620. As more calls and more data are collected, trained model 620 may be treated as an untrained model 612, and may be retrained and refined on further data as they become available.

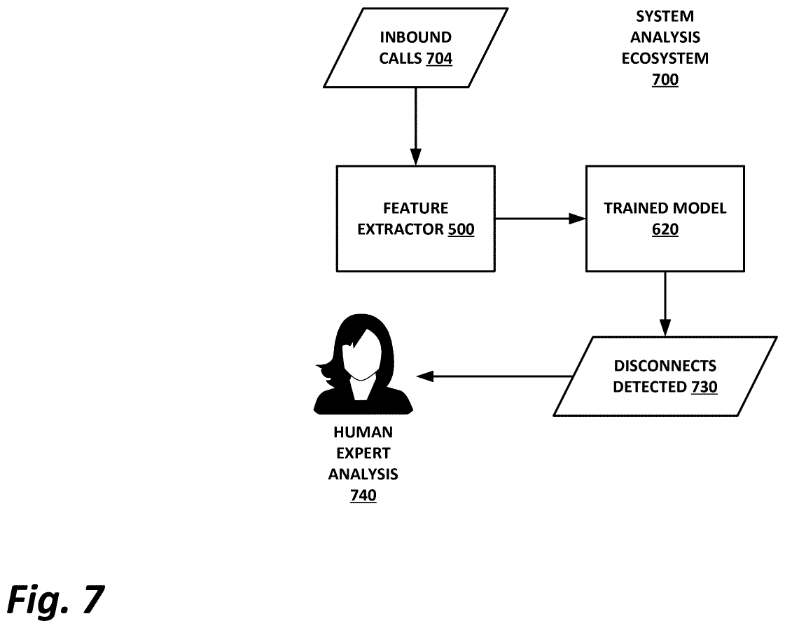

FIG. 7 is a block diagram of selected elements of a system analysis ecosystem 700. In this example, a number of inbound calls 704 come into a service center. System analysis ecosystem 700 includes a feature extractor 500, and trained model 620, which can be used to featurize the calls and recognize when calls are dropped. Trained model 620 can be run in real time, such as immediately after calls, to identify dropped calls, or can be run later on batches of calls. Trained model 620 may provide a set of disconnected or dropped calls 730, that a human expert 740 can analyze to determine root causes and to recommend improvements to avoid future dropped calls. Human expert 740 can also provide valuable feedback for training or retraining model 620. For example human expert 740 can review calls that have been tagged as dropped calls by trained model 620, and verify that they are in fact dropped calls. Human expert 740 may also, in the course of her duties, analyze other calls (e.g., for other purposes), and may identify dropped calls that trained model 620 missed. In that case, human expert 740 can appropriately tag those calls, and provide them in a training data set as in block 608 of FIG. 6.

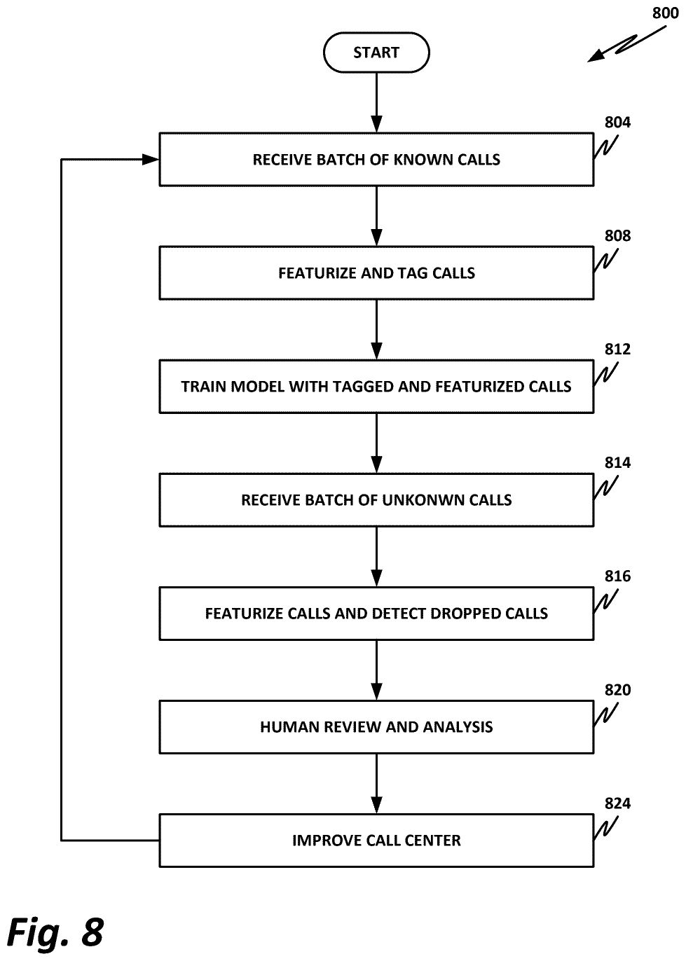

FIG. 8 is a flowchart of a method 800 of analyzing dropped calls.

In block 804, the system receives a batch of known calls.

In block 808, the system may featurize and tag the calls, including by human analysis, at least in the first instance.

In block 812, the system may train an ML model with tagged and featurize calls.

In block 814, the system receives a batch of unknown calls, with the intent of identifying and tagging dropped calls so that they can be further analyzed.

In block 816, the system featurizes the unknown calls and detects and tags dropped calls.

In block 820, a human expert may review and analyze the tagged dropped calls, and may provide valuable functions. This may include correcting tags such as identifying calls that were improperly marked as dropped (false positives), and also identifying calls that should have been tagged as dropped calls but were not (false negatives). The human analyst may also review the calls for root causes, patterns, and may make recommendations for how to improve operations of the call center to avoid dropped calls in the future.

In block 824, feedback from the human analyst and from other operations may be used to improve the IVP or the call center, to provide a better customer service experience.

Once a batch of calls has been analyze, and appropriate tags have been affixed (optionally with review from human users), then those calls may then be treated as known calls, and the method may return to block 804 to further refine the call center.

FIG. 9 is a block diagram of a hardware platform 900. Although a particular configuration is illustrated here, there are many different configurations of hardware platforms, and this embodiment is intended to represent the class of hardware platforms that can provide a computing device. Furthermore, the designation of this embodiment as a “hardware platform” is not intended to require that all embodiments provide all elements in hardware. Some of the elements disclosed herein may be provided, in various embodiments, as hardware, software, firmware, microcode, microcode instructions, hardware instructions, hardware or software accelerators, or similar. Furthermore, in some embodiments, entire computing devices or platforms may be virtualized, on a single device, or in a data center where virtualization may span one or a plurality of devices. For example, in a “rackscale architecture” design, disaggregated computing resources may be virtualized into a single instance of a virtual device. In that case, all of the disaggregated resources that are used to build the virtual device may be considered part of hardware platform 900, even though they may be scattered across a data center, or even located in different data centers.

Hardware platform 900 is configured to provide a computing device. In various embodiments, a “computing device” may be or comprise, by way of nonlimiting example, a computer, workstation, server, mainframe, virtual machine (whether emulated or on a “bare metal” hypervisor), network appliance, container, IoT device, high performance computing (HPC) environment, a data center, a communications service provider infrastructure (e.g., one or more portions of an Evolved Packet Core), an in-memory computing environment, a computing system of a vehicle (e.g., an automobile or airplane), an industrial control system, embedded computer, embedded controller, embedded sensor, personal digital assistant, laptop computer, cellular telephone, internet protocol (IP) telephone, smart phone, tablet computer, convertible tablet computer, computing appliance, receiver, wearable computer, handheld calculator, or any other electronic, microelectronic, or microelectromechanical device for processing and communicating data. At least some of the methods and systems disclosed in this specification may be embodied by or carried out on a computing device.

In the illustrated example, hardware platform 900 is arranged in a point-to-point (PtP) configuration. This PtP configuration is popular for personal computer (PC) and server-type devices, although it is not so limited, and any other bus type may be used.

Hardware platform 900 is an example of a platform that may be used to implement embodiments of the teachings of this specification. For example, instructions could be stored in storage 950. Instructions could also be transmitted to the hardware platform in an ethereal form, such as via a network interface, or retrieved from another source via any suitable interconnect. Once received (from any source), the instructions may be loaded into memory 904, and may then be executed by one or more processor 902 to provide elements such as an operating system 906, operational agents 908, or data 912.

Hardware platform 900 may include several processors 902. For simplicity and clarity, only processors PROC0 902-1 and PROC1 902-2 are shown. Additional processors (such as 2, 4, 8, 16, 24, 32, 64, or 128 processors) may be provided as necessary, while in other embodiments, only one processor may be provided. Processors may have any number of cores, such as 1, 2, 4, 8, 16, 24, 32, 64, or 128 cores.

Processors 902 may be any type of processor and may communicatively couple to chipset 916 via, for example, PtP interfaces. Chipset 916 may also exchange data with other elements, such as a high performance graphics adapter 922. In alternative embodiments, any or all of the PtP links illustrated in FIG. 9 could be implemented as any type of bus, or other configuration rather than a PtP link. In various embodiments, chipset 916 may reside on the same die or package as a processor 902 or on one or more different dies or packages. Each chipset may support any suitable number of processors 902. A chipset 916 (which may be a chipset, uncore, Northbridge, Southbridge, or other suitable logic and circuitry) may also include one or more controllers to couple other components to one or more central processor units (CPU).

Two memories, 904-1 and 904-2 are shown, connected to PROC0 902-1 and PROC1 902-2, respectively. As an example, each processor is shown connected to its memory in a direct memory access (DMA) configuration, though other memory architectures are possible, including ones in which memory 904 communicates with a processor 902 via a bus. For example, some memories may be connected via a system bus, or in a data center, memory may be accessible in a remote DMA (RDMA) configuration.

Memory 904 may include any form of volatile or nonvolatile memory including, without limitation, magnetic media (e.g., one or more tape drives), optical media, flash, random access memory (RAM), double data rate RAM (DDR RAM) nonvolatile RAM (NVRAM), static RAM (SRAM), dynamic RAM (DRAM), persistent RAM (PRAM), data-centric (DC) persistent memory (e.g., Intel Optane/3D-crosspoint), cache, Layer 1 (L1) or Layer 2 (L2) memory, on-chip memory, registers, virtual memory region, read-only memory (ROM), flash memory, removable media, tape drive, cloud storage, or any other suitable local or remote memory component or components. Memory 904 may be used for short, medium, and/or long-term storage. Memory 904 may store any suitable data or information utilized by platform logic. In some embodiments, memory 904 may also comprise storage for instructions that may be executed by the cores of processors 902 or other processing elements (e.g., logic resident on chipsets 916) to provide functionality.

In certain embodiments, memory 904 may comprise a relatively low-latency volatile main memory, while storage 950 may comprise a relatively higher-latency nonvolatile memory. However, memory 904 and storage 950 need not be physically separate devices, and in some examples may represent simply a logical separation of function (if there is any separation at all). It should also be noted that although DMA is disclosed by way of nonlimiting example, DMA is not the only protocol consistent with this specification, and that other memory architectures are available.

Certain computing devices provide main memory 904 and storage 950, for example, in a single physical memory device, and in other cases, memory 904 and/or storage 950 are functionally distributed across many physical devices. In the case of virtual machines or hypervisors, all or part of a function may be provided in the form of software or firmware running over a virtualization layer to provide the logical function, and resources such as memory, storage, and accelerators may be disaggregated (i.e., located in different physical locations across a data center). In other examples, a device such as a network interface may provide only the minimum hardware interfaces necessary to perform its logical operation, and may rely on a software driver to provide additional necessary logic. Thus, each logical block disclosed herein is broadly intended to include one or more logic elements configured and operable for providing the disclosed logical operation of that block. As used throughout this specification, “logic elements” may include hardware, external hardware (digital, analog, or mixed-signal), software, reciprocating software, services, drivers, interfaces, components, modules, algorithms, sensors, components, firmware, hardware instructions, microcode, programmable logic, or objects that can coordinate to achieve a logical operation.

Graphics adapter 922 may be configured to provide a human-readable visual output, such as a command-line interface (CLI) or graphical desktop such as Microsoft Windows, Apple OSX desktop, or a Unix/Linux X Window System-based desktop. Graphics adapter 922 may provide output in any suitable format, such as a coaxial output, composite video, component video, video graphics array (VGA), or digital outputs such as digital visual interface (DVI), FPDLink, DisplayPort, or high definition multimedia interface (HDMI), by way of nonlimiting example. In some examples, graphics adapter 922 may include a hardware graphics card, which may have its own memory and its own graphics processing unit (GPU).

Chipset 916 may be in communication with a bus 928 via an interface circuit. Bus 928 may have one or more devices that communicate over it, such as a bus bridge 932, I/O devices 935, accelerators 946, communication devices 940, and a keyboard and/or mouse 938, by way of nonlimiting example. In general terms, the elements of hardware platform 900 may be coupled together in any suitable manner. For example, a bus may couple any of the components together. A bus may include any known interconnect, such as a multi-drop bus, a mesh interconnect, a fabric, a ring interconnect, a round-robin protocol, a PtP interconnect, a serial interconnect, a parallel bus, a coherent (e.g., cache coherent) bus, a layered protocol architecture, a differential bus, or a Gunning transceiver logic (GTL) bus, by way of illustrative and nonlimiting example.

Communication devices 940 can broadly include any communication not covered by a network interface and the various I/O devices described herein. This may include, for example, various universal serial bus (USB), FireWire, Lightning, or other serial or parallel devices that provide communications.

I/O Devices 935 may be configured to interface with any auxiliary device that connects to hardware platform 900 but that is not necessarily a part of the core architecture of hardware platform 900. A peripheral may be operable to provide extended functionality to hardware platform 900, and may or may not be wholly dependent on hardware platform 900. In some cases, a peripheral may be a computing device in its own right. Peripherals may include input and output devices such as displays, terminals, printers, keyboards, mice, modems, data ports (e.g., serial, parallel, USB, Firewire, or similar), network controllers, optical media, external storage, sensors, transducers, actuators, controllers, data acquisition buses, cameras, microphones, speakers, or external storage, by way of nonlimiting example.

In one example, audio I/O 942 may provide an interface for audible sounds, and may include in some examples a hardware sound card. Sound output may be provided in analog (such as a 3.5 mm stereo jack), component (“RCA”) stereo, or in a digital audio format such as S/PDIF, AES3, AES47, HDMI, USB, Bluetooth, or Wi-Fi audio, by way of nonlimiting example. Audio input may also be provided via similar interfaces, in an analog or digital form.

Bus bridge 932 may be in communication with other devices such as a keyboard/mouse 938 (or other input devices such as a touch screen, trackball, etc.), communication devices 940 (such as modems, network interface devices, peripheral interfaces such as PCI or PCIe, or other types of communication devices that may communicate through a network), audio I/O 942, a data storage device 944, and/or accelerators 946. In alternative embodiments, any portions of the bus architectures could be implemented with one or more PtP links.

Operating system 906 may be, for example, Microsoft Windows, Linux, UNIX, Mac OS X, iOS, MS-DOS, or an embedded or real-time operating system (including embedded or real-time flavors of the foregoing). In some embodiments, a hardware platform 900 may function as a host platform for one or more guest systems that invoke application (e.g., operational agents 908).

Operational agents 908 may include one or more computing engines that may include one or more nontransitory computer-readable mediums having stored thereon executable instructions operable to instruct a processor to provide operational functions. At an appropriate time, such as upon booting hardware platform 900 or upon a command from operating system 906 or a user or security administrator, a processor 902 may retrieve a copy of the operational agent (or software portions thereof) from storage 950 and load it into memory 904. Processor 902 may then iteratively execute the instructions of operational agents 908 to provide the desired methods or functions.

As used throughout this specification, an “engine” includes any combination of one or more logic elements, of similar or dissimilar species, operable for and configured to perform one or more methods provided by the engine. In some cases, the engine may be or include a special integrated circuit designed to carry out a method or a part thereof, a field-programmable gate array (FPGA) programmed to provide a function, a special hardware or microcode instruction, other programmable logic, and/or software instructions operable to instruct a processor to perform the method. In some cases, the engine may run as a “daemon” process, background process, terminate-and-stay-resident program, a service, system extension, control panel, bootup procedure, basic in/output system (BIOS) subroutine, or any similar program that operates with or without direct user interaction. In certain embodiments, some engines may run with elevated privileges in a “driver space” associated with ring 0, 1, or 2 in a protection ring architecture. The engine may also include other hardware, software, and/or data, including configuration files, registry entries, application programming interfaces (APIs), and interactive or user-mode software by way of nonlimiting example.

In some cases, the function of an engine is described in terms of a “circuit” or “circuitry to” perform a particular function. The terms “circuit” and “circuitry” should be understood to include both the physical circuit, and in the case of a programmable circuit, any instructions or data used to program or configure the circuit.

Where elements of an engine are embodied in software, computer program instructions may be implemented in programming languages, such as an object code, an assembly language, or a high-level language such as OpenCL, FORTRAN, C, C++, JAVA, or HTML. These may be used with any compatible operating systems or operating environments. Hardware elements may be designed manually, or with a hardware description language such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

A network interface may be provided to communicatively couple hardware platform 900 to a wired or wireless network or fabric. A “network,” as used throughout this specification, may include any communicative platform operable to exchange data or information within or between computing devices, including, by way of nonlimiting example, a local network, a switching fabric, an ad-hoc local network, Ethernet (e.g., as defined by the IEEE 802.3 standard), Fiber Channel, InfiniBand, Wi-Fi, or other suitable standard. Intel Omni-Path Architecture (OPA), TrueScale, Ultra Path Interconnect (UPI) (formerly called QuickPath Interconnect, QPI, or KTI), FibreChannel, Ethernet, FibreChannel over Ethernet (FCoE), InfiniBand, PCI, PCIe, fiber optics, millimeter wave guide, an internet architecture, a packet data network (PDN) offering a communications interface or exchange between any two nodes in a system, a local area network (LAN), metropolitan area network (MAN), wide area network (WAN), wireless local area network (WLAN), virtual private network (VPN), intranet, plain old telephone system (POTS), or any other appropriate architecture or system that facilitates communications in a network or telephonic environment, either with or without human interaction or intervention. A network interface may include one or more physical ports that may couple to a cable (e.g., an Ethernet cable, other cable, or waveguide).

In some cases, some or all of the components of hardware platform 900 may be virtualized, in particular the processor(s) and memory. For example, a virtualized environment may run on OS 906, or OS 906 could be replaced with a hypervisor or virtual machine manager. In this configuration, a virtual machine running on hardware platform 900 may virtualize workloads. A virtual machine in this configuration may perform essentially all of the functions of a physical hardware platform.

In a general sense, any suitably-configured processor can execute any type of instructions associated with the data to achieve the operations illustrated in this specification. Any of the processors or cores disclosed herein could transform an element or an article (for example, data) from one state or thing to another state or thing. In another example, some activities outlined herein may be implemented with fixed logic or programmable logic (for example, software and/or computer instructions executed by a processor).

Various components of the system depicted in FIG. 9 may be combined in a SoC architecture or in any other suitable configuration. For example, embodiments disclosed herein can be incorporated into systems including mobile devices such as smart cellular telephones, tablet computers, personal digital assistants, portable gaming devices, and similar. These mobile devices may be provided with SoC architectures in at least some embodiments. An example of such an embodiment is provided in FIGURE QC. Such an SoC (and any other hardware platform disclosed herein) may include analog, digital, and/or mixed-signal, radio frequency (RF), or similar processing elements. Other embodiments may include a multichip module (MCM), with a plurality of chips located within a single electronic package and configured to interact closely with each other through the electronic package. In various other embodiments, the computing functionalities disclosed herein may be implemented in one or more silicon cores in application-specific integrated circuits (ASICs), FPGAs, and other semiconductor chips.

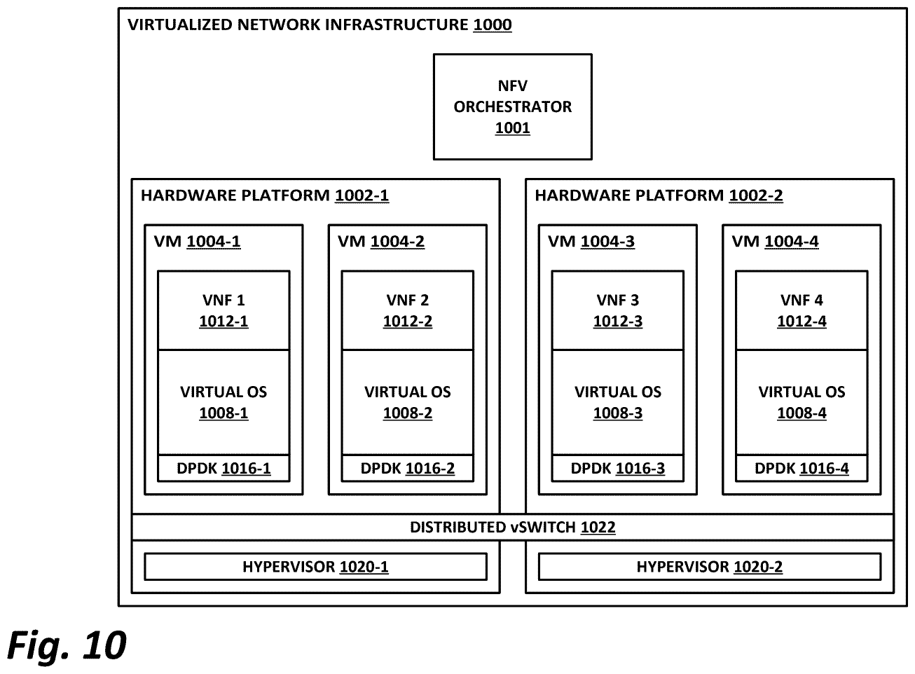

FIG. 10 is a block diagram of a NFV infrastructure 1000. NFV is an example of virtualization, and the virtualization infrastructure here can also be used to realize traditional VMs. Various functions described above may be realized as VMs, including any of the functions related to detecting and remediating dropped calls.

NFV is generally considered distinct from software defined networking (SDN), but they can interoperate together, and the teachings of this specification should also be understood to apply to SDN in appropriate circumstances. For example, virtual network functions (VNFs) may operate within the data plane of an SDN deployment. NFV was originally envisioned as a method for providing reduced capital expenditure (Capex) and operating expenses (Opex) for telecommunication services. One feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, VNFs can be provisioned (“spun up”) or removed (“spun down”) to meet network demands. For example, in times of high load, more load balancing VNFs may be spun up to distribute traffic to more workload servers (which may themselves be VMs). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI), such as NFVI 1000. Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

In the example of FIG. 10, an NFV orchestrator 1001 may manage several VNFs 1012 running on an NFVI 1000. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus making NFV orchestrator 1001 a valuable system resource. Note that NFV orchestrator 1001 may provide a browser-based or graphical configuration interface, and in some embodiments may be integrated with SDN orchestration functions.

Note that NFV orchestrator 1001 itself may be virtualized (rather than a special-purpose hardware appliance). NFV orchestrator 1001 may be integrated within an existing SDN system, wherein an operations support system (OSS) manages the SDN. This may interact with cloud resource management systems (e.g., OpenStack) to provide NFV orchestration. An NFVI 1000 may include the hardware, software, and other infrastructure to enable VNFs to run. This may include a hardware platform 1002 on which one or more VMs 1004 may run. For example, hardware platform 1002-1 in this example runs VMs 1004-1 and 1004-2. Hardware platform 1002-2 runs VMs 1004-3 and 1004-4. Each hardware platform 1002 may include a respective hypervisor 1020, virtual machine manager (VMM), or similar function, which may include and run on a native (bare metal) operating system, which may be minimal so as to consume very few resources. For example, hardware platform 1002-1 has hypervisor 1020-1, and hardware platform 1002-2 has hypervisor 1020-2.

Hardware platforms 1002 may be or comprise a rack or several racks of blade or slot servers (including, e.g., processors, memory, and storage), one or more data centers, other hardware resources distributed across one or more geographic locations, hardware switches, or network interfaces. An NFVI 1000 may also include the software architecture that enables hypervisors to run and be managed by NFV orchestrator 1001.

Running on NFVI 1000 are VMs 1004, each of which in this example is a VNF providing a virtual service appliance. Each VM 1004 in this example includes an instance of the Data Plane Development Kit (DPDK) 1016, a virtual operating system 1008, and an application providing the VNF 1012. For example, VM 1004-1 has virtual OS 1008-1, DPDK 1016-1, and VNF 1012-1. VM 1004-2 has virtual OS 1008-2, DPDK 1016-2, and VNF 1012-2. VM 1004-3 has virtual OS 1008-3, DPDK 1016-3, and VNF 1012-3. VM 1004-4 has virtual OS 1008-4, DPDK 1016-4, and VNF 1012-4.

Virtualized network functions could include, as nonlimiting and illustrative examples, firewalls, intrusion detection systems, load balancers, routers, session border controllers, DPI services, network address translation (NAT) modules, or call security association.

The illustration of FIG. 10 shows that a number of VNFs 1004 have been provisioned and exist within NFVI 1000. This FIGURE does not necessarily illustrate any relationship between the VNFs and the larger network, or the packet flows that NFVI 1000 may employ.

The illustrated DPDK instances 1016 provide a set of highly-optimized libraries for communicating across a virtual switch (vSwitch) 1022. Like VMs 1004, vSwitch 1022 is provisioned and allocated by a hypervisor 1020. The hypervisor uses a network interface to connect the hardware platform to the data center fabric (e.g., a host fabric interface (HFI)). This HFI may be shared by all VMs 1004 running on a hardware platform 1002. Thus, a vSwitch may be allocated to switch traffic between VMs 1004. The vSwitch may be a pure software vSwitch (e.g., a shared memory vSwitch), which may be optimized so that data are not moved between memory locations, but rather, the data may stay in one place, and pointers may be passed between VMs 1004 to simulate data moving between ingress and egress ports of the vSwitch. The vSwitch may also include a hardware driver (e.g., a hardware network interface IP block that switches traffic, but that connects to virtual ports rather than physical ports). In this illustration, a distributed vSwitch 1022 is illustrated, wherein vSwitch 1022 is shared between two or more physical hardware platforms 1002.

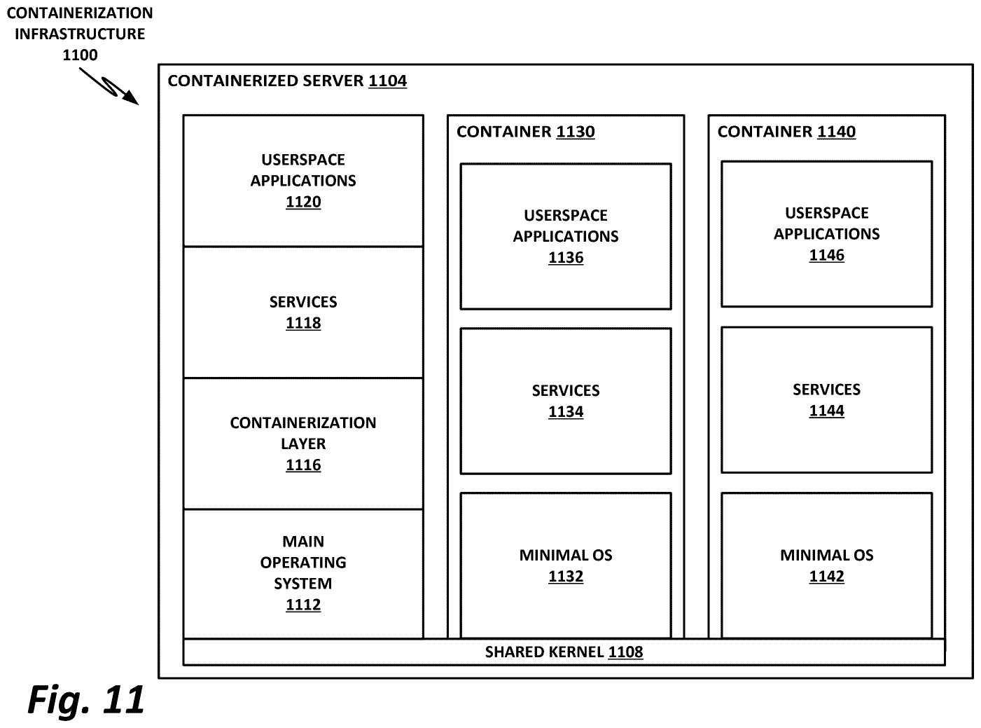

FIG. 11 is a block diagram of selected elements of a containerization infrastructure 1100. Like virtualization, containerization is a popular form of providing a guest infrastructure. Various functions described herein may be containerized, including any of the functions related to detecting and remediating dropped calls.

Containerization infrastructure 1100 runs on a hardware platform such as containerized server 1104. Containerized server 1104 may provide processors, memory, one or more network interfaces, accelerators, and/or other hardware resources.

Running on containerized server 1104 is a shared kernel 1108. One distinction between containerization and virtualization is that containers run on a common kernel with the main operating system and with each other. In contrast, in virtualization, the processor and other hardware resources are abstracted or virtualized, and each virtual machine provides its own kernel on the virtualized hardware.

Running on shared kernel 1108 is main operating system 1112. Commonly, main operating system 1112 is a Unix or Linux-based operating system, although containerization infrastructure is also available for other types of systems, including Microsoft Windows systems and Macintosh systems. Running on top of main operating system 1112 is a containerization layer 1116. For example, Docker is a popular containerization layer that runs on a number of operating systems, and relies on the Docker daemon. Newer operating systems (including Fedora Linux 32 and later) that use version 2 of the kernel control groups service (cgroups v2) feature appear to be incompatible with the Docker daemon. Thus, these systems may run with an alternative known as Podman that provides a containerization layer without a daemon.

Various factions debate the advantages and/or disadvantages of using a daemon-based containerization layer (e.g., Docker) versus one without a daemon (e.g., Podman). Such debates are outside the scope of the present specification, and when the present specification speaks of containerization, it is intended to include any containerization layer, whether it requires the use of a daemon or not.

Main operating system 1112 may also provide services 1118, which provide services and interprocess communication to userspace applications 1120.

Services 1118 and userspace applications 1120 in this illustration are independent of any container.

As discussed above, a difference between containerization and virtualization is that containerization relies on a shared kernel. However, to maintain virtualization-like segregation, containers do not share interprocess communications, services, or many other resources. Some sharing of resources between containers can be approximated by permitting containers to map their internal file systems to a common mount point on the external file system. Because containers have a shared kernel with the main operating system 1112, they inherit the same file and resource access permissions as those provided by shared kernel 1108. For example, one popular application for containers is to run a plurality of web servers on the same physical hardware. The Docker daemon provides a shared socket, docker.sock, that is accessible by containers running under the same Docker daemon. Thus, one container can be configured to provide only a reverse proxy for mapping hypertext transfer protocol (HTTP) and hypertext transfer protocol secure (HTTPS) requests to various containers. This reverse proxy container can listen on docker.sock for newly spun up containers. When a container spins up that meets certain criteria, such as by specifying a listening port and/or virtual host, the reverse proxy can map HTTP or HTTPS requests to the specified virtual host to the designated virtual port. Thus, only the reverse proxy host may listen on ports 80 and 443, and any request to subdomain1.example.com may be directed to a virtual port on a first container, while requests to subdomain2.example.com may be directed to a virtual port on a second container.

Other than this limited sharing of files or resources, which generally is explicitly configured by an administrator of containerized server 1104, the containers themselves are completely isolated from one another. However, because they share the same kernel, it is relatively easier to dynamically allocate compute resources such as CPU time and memory to the various containers. Furthermore, it is common practice to provide only a minimum set of services on a specific container, and the container does not need to include a full bootstrap loader because it shares the kernel with a containerization host (i.e. containerized server 1104).

Thus, “spinning up” a container is often relatively faster than spinning up a new virtual machine that provides a similar service. Furthermore, a containerization host does not need to virtualize hardware resources, so containers access those resources natively and directly. While this provides some theoretical advantages over virtualization, modern hypervisors-especially type 1, or “bare metal,” hypervisors-provide such near-native performance that this advantage may not always be realized.

In this example, containerized server 1104 hosts two containers, namely container 1130 and container 1140.

Container 1130 may include a minimal operating system 1132 that runs on top of shared kernel 1108. Note that a minimal operating system is provided as an illustrative example, and is not mandatory. In fact, container 1130 may perform as full an operating system as is necessary or desirable. Minimal operating system 1132 is used here as an example simply to illustrate that in common practice, the minimal operating system necessary to support the function of the container (which in common practice, is a single or monolithic function) is provided.

On top of minimal operating system 1132, container 1130 may provide one or more services 1134. Finally, on top of services 1134, container 1130 may also provide userspace applications 1136, as necessary.

Container 1140 may include a minimal operating system 1142 that runs on top of shared kernel 1108. Note that a minimal operating system is provided as an illustrative example, and is not mandatory. In fact, container 1140 may perform as full an operating system as is necessary or desirable. Minimal operating system 1142 is used here as an example simply to illustrate that in common practice, the minimal operating system necessary to support the function of the container (which in common practice, is a single or monolithic function) is provided.

On top of minimal operating system 1142, container 1140 may provide one or more services 1144. Finally, on top of services 1144, container 1140 may also provide userspace applications 1146, as necessary.

Using containerization layer 1116, containerized server 1104 may run discrete containers, each one providing the minimal operating system and/or services necessary to provide a particular function. For example, containerized server 1104 could include a mail server, a web server, a secure shell server, a file server, a weblog, cron services, a database server, and many other types of services. In theory, these could all be provided in a single container, but security and modularity advantages are realized by providing each of these discrete functions in a discrete container with its own minimal operating system necessary to provide those services.

FIGS. 12 and 13 illustrate selected elements of an artificial intelligence system or architecture. In these FIGURES, an elementary neural network is used as a representative embodiment of an artificial intelligence (AI) or machine learning (ML) architecture or engine. These figures represent a nonlimiting example AI. The purpose of these figures is not necessarily to exhaustively reproduce the AI elements of the present specification. The AI principles disclosed in this specification are well-understood in the art, and the system and method for detecting dropped calls disclosed herein are not intended to claim AI itself as a novel technology. Rather, the content independent dropped call detection system and method illustrate a novel application of known AI principles. Thus, the figures provided here are intended to review some foundational concepts of AI (particularly “deep learning” in the context of a deep neural network) and provide a meaningful vocabulary for discussion of AI terms used throughout this specification.

The deep learning network illustrated here should thus be understood to represent AI principles in general. Other machine learning or artificial intelligence architectures are available, including for example symbolic learning, robotics, computer vision, pattern recognition, statistical learning, speech recognition, natural language processing, deep learning, convolutional neural networks, recurrent neural networks, object recognition and/or others.

FIG. 12 illustrates machine learning according to a “textbook” problem with real-world applications. In this case, a neural network 1200 is tasked with recognizing characters. To simplify the description, neural network 1200 is tasked only with recognizing single digits in the range of 0 through 9. These are provided as an input image 1204. In this example, input image 1204 is a 28×28-pixel 8-bit grayscale image. In other words, input image 1204 is a square that is 28 pixels wide and 28 pixels high. Each pixel has a value between 0 and 255, with 0 representing white or no color, and 255 representing black or full color, with values in between representing various shades of gray. This provides a straightforward problem space to illustrate the operative principles of a neural network. Only selected elements of neural network 1200 are illustrated in this FIGURE, and that real-world applications may be more complex, and may include additional features, such as the use of multiple channels (e.g., for a color image, there may be three distinct channels for red, green, and blue). Additional layers of complexity or functions may be provided in a neural network, or other artificial intelligence architecture, to meet the demands of a particular problem. Indeed, the architecture here is sometimes referred to as the “Hello World” problem of machine learning, and is provided as but one example of how the machine learning or artificial intelligence functions of the present specification could be implemented.

In this case, neural network 1200 includes an input layer 1212 and an output layer 1220. In principle, input layer 1212 receives an input such as input image 1204, and at output layer 1220, neural network 1200 “lights up” a perceptron that indicates which character neural network 1200 thinks is represented by input image 1204.

Between input layer 1212 and output layer 1220 are some number of hidden layers 1216. The number of hidden layers 1216 will depend on the problem to be solved, the available compute resources, and other design factors. In general, the more hidden layers 1216, and the more neurons per hidden layer, the more accurate the neural network 1200 may become. However, adding hidden layers and neurons also increases the complexity of the neural network, and its demand on compute resources. Thus, some design skill is required to determine the appropriate number of hidden layers 1216, and how many neurons are to be represented in each hidden layer 1216.

Input layer 1212 includes, in this example, 784 “neurons” 1208. Each neuron of input layer 1212 receives information from a single pixel of input image 1204. Because input image 1204 is a 28×28 grayscale image, it has 784 pixels. Thus, each neuron in input layer 1212 holds 8 bits of information, taken from a pixel of input layer 1204. This 8-bit value is the “activation” value for that neuron.

Each neuron in input layer 1212 has a connection to each neuron in the first hidden layer in the network. In this example, the first hidden layer has neurons labeled 0 through M. Each of the M+1 neurons is connected to all 784 neurons in input layer 1212. Each neuron in hidden layer 1216 includes a kernel or transfer function, which is described in greater detail below. The kernel or transfer function determines how much “weight” to assign each connection from input layer 1212. In other words, a neuron in hidden layer 1216 may think that some pixels are more important to its function than other pixels. Based on this transfer function, each neuron computes an activation value for itself, which may be for example a decimal number between 0 and 1.

A common operation for the kernel is convolution, in which case the neural network may be referred to as a “convolutional neural network” (CNN). The case of a network with multiple hidden layers between the input layer and output layer may be referred to as a “deep neural network” (DNN). A DNN may be a CNN, and a CNN may be a DNN, but neither expressly implies the other.

Each neuron in this layer is also connected to each neuron in the next layer, which has neurons from 0 to N. As in the previous layer, each neuron has a transfer function that assigns a particular weight to each of its M+1 connections and computes its own activation value. In this manner, values are propagated along hidden layers 1216, until they reach the last layer, which has P+1 neurons labeled 0 through P. Each of these P+1 neurons has a connection to each neuron in output layer 1220. Output layer 1220 includes a number of neurons known as perceptrons that compute an activation value based on their weighted connections to each neuron in the last hidden layer 1216. The final activation value computed at output layer 1220 may be thought of as a “probability” that input image 1204 is the value represented by the perceptron. For example, if neural network 1200 operates perfectly, then perceptron 4 would have a value of 1.00, while each other perceptron would have a value of 0.00. This would represent a theoretically perfect detection. In practice, detection is not generally expected to be perfect, but it is desirable for perceptron 4 to have a value close to 1, while the other perceptrons have a value close to 0.

Conceptually, neurons in the hidden layers 1216 may correspond to “features.” For example, in the case of computer vision, the task of recognizing a character may be divided into recognizing features such as the loops, lines, curves, or other features that make up the character. Recognizing each loop, line, curve, etc., may be further divided into recognizing smaller elements (e.g., line or curve segments) that make up that feature. Moving through the hidden layers from left to right, it is often expected and desired that each layer recognizes the “building blocks” that make up the features for the next layer. In practice, realizing this effect is itself a nontrivial problem, and may require greater sophistication in programming and training than is fairly represented in this simplified example.

The activation value for neurons in the input layer is simply the value taken from the corresponding pixel in the bitmap. The activation value (a) for each neuron in succeeding layers is computed according to a transfer function, which accounts for the “strength” of each of its connections to each neuron in the previous layer. The transfer can be written as a sum of weighted inputs (i.e., the activation value (a) received from each neuron in the previous layer, multiplied by a weight representing the strength of the neuron-to-neuron connection (w)), plus a bias value.

The weights may be used, for example, to “select” a region of interest in the pixmap that corresponds to a “feature” that the neuron represents. Positive weights may be used to select the region, with a higher positive magnitude representing a greater probability that a pixel in that region (if the activation value comes from the input layer) or a subfeature (if the activation value comes from a hidden layer) corresponds to the feature. Negative weights may be used for example to actively “de-select” surrounding areas or subfeatures (e.g., to mask out lighter values on the edge), which may be used for example to clean up noise on the edge of the feature. Pixels or subfeatures far removed from the feature may have for example a weight of zero, meaning those pixels should not contribute to examination of the feature.

The bias (b) may be used to set a “threshold” for detecting the feature. For example, a large negative bias indicates that the “feature” should be detected only if it is strongly detected, while a large positive bias makes the feature much easier to detect.

The biased weighted sum yields a number with an arbitrary sign and magnitude. This real number can then be normalized to a final value between 0 and 1, representing (conceptually) a probability that the feature this neuron represents was detected from the inputs received from the previous layer. Normalization may include a function such as a step function, a sigmoid, a piecewise linear function, a Gaussian distribution, a linear function or regression, or the popular “rectified linear unit” (ReLU) function. In the examples of this specification, a sigmoid function notation (σ) is used by way of illustrative example, but it should be understood to stand for any normalization function or algorithm used to compute a final activation value in a neural network.

The transfer function for each neuron in a layer yields a scalar value. For example, the activation value for neuron “0” in layer “1” (the first hidden layer), may be written as:

$${a}_{0}^{( 1 )} = σ ( {w}_{0} {a}_{0}^{( 0 )} + {w}_{1} {a}_{1}^{( 0 )} + … {w}_{783} {a}_{783}^{( 0 )} + b )$$

In this case, it is assumed that layer 0 (input layer 1212) has 784 neurons. Where the previous layer has “n” neurons, the function can be generalized as:

$${a}_{0}^{( 1 )} = σ ( {w}_{0} {a}_{0}^{( 0 )} + {w}_{1} {a}_{1}^{( 0 )} + … {w}_{n} {a}_{n}^{( 0 )} + b )$$

A similar function is used to compute the activation value of each neuron in layer 1 (the first hidden layer), weighted with that neuron's strength of connections to each neuron in layer 0, and biased with some threshold value. As discussed above, the sigmoid function shown here is intended to stand for any function that normalizes the output to a value between 0 and 1.

The full transfer function for layer 1 (with k neurons in layer 1) may be written in matrix notation as:

$${a}^{( 1 )} = σ ( [ \begin{matrix}{w}_{0 , 0} & … & {w}_{0 , n} \\ ⋮ & ⋱ & ⋮ \\ {w}_{( k , 0 )} & … & {w}_{k , n}\end{matrix} ] [ \begin{matrix}{a}_{0}^{( 0 )} \\ ⋮ \\ {a}_{n}^{( 0 )}\end{matrix} ] + [ \begin{matrix}{b}_{0} \\ ⋮ \\ {b}_{n}\end{matrix} ] )$$

More compactly, the full transfer function for layer 1 can be written in vector notation as:

$${a}^{( 1 )} = σ ( {Wa}^{( 0 )} + b )$$

Neural connections and activation values are propagated throughout the hidden layers 1216 of the network in this way, until the network reaches output layer 1220. At output layer 1220, each neuron is a “bucket” or classification, with the activation value representing a probability that the input object should be classified to that perceptron. The classifications may be mutually exclusive or multinominal. For example, in the computer vision example of character recognition, a character may best be assigned only one value, or in other words, a single character is not expected to be simultaneously both a “4” and a “9.” In that case, the neurons in output layer 1220 are binomial perceptrons. Ideally, only one value is above the threshold, causing the perceptron to metaphorically “light up,” and that value is selected. In the case where multiple perceptrons light up, the one with the highest probability may be selected. The result is that only one value (in this case, “4”) should be lit up, while the rest should be “dark.” Indeed, if the neural network were theoretically perfect, the “4” neuron would have an activation value of 1.00, while each other neuron would have an activation value of 0.00.

In the case of multinominal perceptrons, more than one output may be lit up. For example, a neural network may determine that a particular document has high activation values for perceptrons corresponding to several departments, such as Accounting, Information Technology (IT), and Human Resources. On the other hand, the activation values for perceptrons for Legal, Manufacturing, and Shipping are low. In the case of multinominal classification, a threshold may be defined, and any neuron in the output layer with a probability above the threshold may be considered a “match” (e.g., the document is relevant to those departments). Those below the threshold are considered not a match (e.g., the document is not relevant to those departments).

The weights and biases of the neural network act as parameters, or “controls,” wherein features in a previous layer are detected and recognized. When the neural network is first initialized, the weights and biases may be assigned randomly or pseudo-randomly. Thus, because the weights-and-biases controls are garbage, the initial output is expected to be garbage. In the case of a “supervised” learning algorithm, the network is refined by providing a “training” set, which includes objects with known results. Because the correct answer for each object is known, training sets can be used to iteratively move the weights and biases away from garbage values, and toward more useful values.

A common method for refining values includes “gradient descent” and “back-propagation.” An illustrative gradient descent method includes computing a “cost” function, which measures the error in the network. For example, in the illustration, the “4” perceptron ideally has a value of “1.00,” while the other perceptrons have an ideal value of “0.00.” The cost function takes the difference between each output and its ideal value, squares the difference, and then takes a sum of all of the differences. Each training example will have its own computed cost. Initially, the cost function is very large, because the network does not know how to classify objects. As the network is trained and refined, the cost function value is expected to get smaller, as the weights and biases are adjusted toward more useful values.

With, for example, 100,000 training examples in play, an average cost (e.g., a mathematical mean) can be computed across all 100,00 training examples. This average cost provides a quantitative measurement of how “badly” the neural network is doing its detection job.

The cost function can thus be thought of as a single, very complicated formula, where the inputs are the parameters (weights and biases) of the network. Because the network may have thousands or even millions of parameters, the cost function has thousands or millions of input variables. The output is a single value representing a quantitative measurement of the error of the network. The cost function can be represented as:

C(w)

Wherein w is a vector containing all of the parameters (weights and biases) in the network. The minimum (absolute and/or local) can then be represented as a trivial calculus problem, namely:

$$\frac{dC}{dw} ( w ) = 0$$

Solving such a problem symbolically may be prohibitive, and in some cases not even possible, even with heavy computing power available. Rather, neural networks commonly solve the minimizing problem numerically. For example, the network can compute the slope of the cost function at any given point, and then shift by some small amount depending on whether the slope is positive or negative. The magnitude of the adjustment may depend on the magnitude of the slope. For example, when the slope is large, it is expected that the local minimum is “far away,” so larger adjustments are made. As the slope lessens, smaller adjustments are made to avoid badly overshooting the local minimum. In terms of multi-vector calculus, this is a gradient function of many variables:

−∇C(w)

The value of −∇C is simply a vector of the same number of variables as w, indicating which direction is “down” for this multivariable cost function. For each value in −∇C, the sign of each scalar tells the network which “direction” the value needs to be nudged, and the magnitude of each scalar can be used to infer which values are most “important” to change.

Gradient descent involves computing the gradient function, taking a small step in the “downhill” direction of the gradient (with the magnitude of the step depending on the magnitude of the gradient), and then repeating until a local minimum has been found within a threshold.

While finding a local minimum is relatively straightforward once the value of −∇C, finding an absolute minimum is many times harder, particularly when the function has thousands or millions of variables. Thus, common neural networks consider a local minimum to be “good enough,” with adjustments possible if the local minimum yields unacceptable results. Because the cost function is ultimately an average error value over the entire training set, minimizing the cost function yields a (locally) lowest average error.

In many cases, the most difficult part of gradient descent is computing the value of −∇C. As mentioned above, computing this symbolically or exactly would be prohibitively difficult. A more practical method is to use back-propagation to numerically approximate a value for −∇C. Back-propagation may include, for example, examining an individual perceptron at the output layer, and determining an average cost value for that perceptron across the whole training set. Taking the “4” perceptron as an example, if the input image is a 4, it is desirable for the perceptron to have a value of 1.00, and for any input images that are not a 4, it is desirable to have a value of 0.00. Thus, an overall or average desired adjustment for the “4” perceptron can be computed.

However, the perceptron value is not hard-coded, but rather depends on the activation values received from the previous layer. The parameters of the perceptron itself (weights and bias) can be adjusted, but it may also be desirable to receive different activation values from the previous layer. For example, where larger activation values are received from the previous layer, the weight is multiplied by a larger value, and thus has a larger effect on the final activation value of the perceptron. The perceptron metaphorically “wishes” that certain activations from the previous layer were larger or smaller. Those wishes can be back-propagated to the previous layer neurons.

At the next layer, the neuron accounts for the wishes from the next downstream layer in determining its own preferred activation value. Again, at this layer, the activation values are not hard-coded. Each neuron can adjust its own weights and biases, and then back-propagate changes to the activation values that it wishes would occur. The back-propagation continues, layer by layer, until the weights and biases of the first hidden layer are set. This layer cannot back-propagate desired changes to the input layer, because the input layer receives activation values directly from the input image.

After a round of such nudging, the network may receive another round of training with the same or a different training data set, and the process is repeated until a local and/or global minimum value is found for the cost function.

FIG. 13 is a flowchart of a method 1300. Method 1300 may be used to train a neural network, such as neural network 1200 of FIG. 12.

In block 1304, the network is initialized. Initially, neural network 1200 includes some number of neurons. Each neuron includes a transfer function or kernel. In the case of a neural network, each neuron includes parameters such as the weighted sum of values of each neuron from the previous layer, plus a bias. The final value of the neuron may be normalized to a value between 0 and 1, using a function such as the sigmoid or ReLU. Because the untrained neural network knows nothing about its problem space, and because it would be very difficult to manually program the neural network to perform the desired function, the parameters for each neuron may initially be set to just some random value. For example, the values may be selected using a pseudorandom number generator of a CPU, and then assigned to each neuron.

In block 1308, the neural network is provided a training set. In some cases, the training set may be divided up into smaller groups. For example, if the training set has 100,000 objects, this may be divided into 1,000 groups, each having 100 objects. These groups can then be used to incrementally train the neural network. In block 1308, the initial training set is provided to the neural network. Alternatively, the full training set could be used in each iteration.

In block 1312, the training data are propagated through the neural network. Because the initial values are random, and are therefore essentially garbage, it is expected that the output will also be a garbage value. In other words, if neural network 1200 of FIG. 12 has not been trained, when input image 1204 is fed into the neural network, it is not expected with the first training set that output layer 1220 will light up perceptron 4. Rather, the perceptrons may have values that are all over the map, with no clear winner, and with very little relation to the number 4.

In block 1316, a cost function is computed as described above. For example, in neural network 1200, it is desired for perceptron 4 to have a value of 1.00, and for each other perceptron to have a value of 0.00. The difference between the desired value and the actual output value is computed and squared. Individual cost functions can be computed for each training input, and the total cost function for the network can be computed as an average of the individual cost functions.

In block 1320, the network may then compute a negative gradient of this cost function to seek a local minimum value of the cost function, or in other words, the error. For example, the system may use back-propagation to seek a negative gradient numerically. After computing the negative gradient, the network may adjust parameters (weights and biases) by some amount in the “downward” direction of the negative gradient.

After computing the negative gradient, in decision block 1324, the system determines whether it has reached a local minimum (e.g., whether the gradient has reached 0 within the threshold). If the local minimum has not been reached, then the neural network has not been adequately trained, and control returns to block 1308 with a new training set. The training sequence continues until, in block 1324, a local minimum has been reached.

Now that a local minimum has been reached and the corrections have been back-propagated, in block 1332, the neural network is ready.

Although FIGS. 12 and 13 illustrate an AI application for recognizing characters, that function does not represent the limit of modern-day AI practice. AIs have been adapted to many tasks, and generative AIs (GAI) are also common now. For example, generative pre-trained transformer (GPT) networks are popular for their ability to naturally interact with human users, effectively imitating human speech patterns. GAI networks have also been trained for creating and modifying art, engineering designs, books, and other information.

Many of the foregoing GAIs are general-purpose GAIs, meaning that they are trained on very large data sets (e.g., on the order of many terabytes of data), and have general knowledge on many subjects. However, domain-specific AIs are also used in other contexts. General-purpose AIs are generally trained on very large data sets in an unsupervised or semi-unsupervised regimen, which provides the breadth that may benefit a general-purpose AI. Domain-specific AIs are often based on general-purpose AIs, and may start from a pre-trained model. The pre-trained model can then be refined and re-trained using supervised learning, such as with structured, curated, and tagged data sets. This supervised learning can morph the AI model into a model that has specialized utility in a specific knowledge domain.

The foregoing outlines features of several embodiments so that those skilled in the art may better understand various aspects of the present disclosure. The foregoing detailed description sets forth examples of apparatuses, methods, and systems relating to content independent dropped call detection in accordance with one or more embodiments of the present disclosure. Features such as structure(s), function(s), and/or characteristic(s), for example, are described with reference to one embodiment as a matter of convenience; various embodiments may be implemented with any suitable one or more of the described features.

As used throughout this specification, the phrase “an embodiment” is intended to refer to one or more embodiments. Furthermore, different uses of the phrase “an embodiment” may refer to different embodiments. The phrases “in another embodiment” or “in a different embodiment” refer to an embodiment different from the one previously described, or the same embodiment with additional features. For example, “in an embodiment, features may be present. In another embodiment, additional features may be present.” The foregoing example could first refer to an embodiment with features A, B, and C, while the second could refer to an embodiment with features A, B, C, and D, with features, A, B, and D, with features, D, E, and F, or any other variation.

In the foregoing description, various aspects of the illustrative implementations may be described using terms commonly employed by those skilled in the art to convey the substance of their work to others skilled in the art. It will be apparent to those skilled in the art that the embodiments disclosed herein may be practiced with only some of the described aspects. For purposes of explanation, specific numbers, materials, and configurations are set forth to provide a thorough understanding of the illustrative implementations. In some cases, the embodiments disclosed may be practiced without specific details. In other instances, well-known features are omitted or simplified so as not to obscure the illustrated embodiments.

For the purposes of the present disclosure and the appended claims, the article “a” refers to one or more of an item. The phrase “A or B” is intended to encompass the “inclusive or,” e.g., A, B, or (A and B). “A and/or B” means A, B, or (A and B). For the purposes of the present disclosure, the phrase “A, B, and/or C” means A, B, C, (A and B), (A and C), (B and C), or (A, B, and C).

The embodiments disclosed can readily be used as the basis for designing or modifying other processes and structures to carry out the teachings of the present specification. Any equivalent constructions to those disclosed do not depart from the spirit and scope of the present disclosure. Design considerations may result in substitute arrangements, design choices, device possibilities, hardware configurations, software implementations, and equipment options.

As used throughout this specification, a “memory” is expressly intended to include both a volatile memory and a nonvolatile memory. Thus, for example, an “engine” as described above could include instructions encoded within a volatile or nonvolatile memory that, when executed, instruct a processor to perform the operations of any of the methods or procedures disclosed herein. It is expressly intended that this configuration reads on a computing apparatus “sitting on a shelf” in a non-operational state. For example, in this example, the “memory” could include one or more tangible, nontransitory computer-readable storage media that contain stored instructions. These instructions, in conjunction with the hardware platform (including a processor) on which they are stored may constitute a computing apparatus.

In other embodiments, a computing apparatus may also read on an operating device. For example, in this configuration, the “memory” could include a volatile or run-time memory (e.g., RAM), where instructions have already been loaded. These instructions, when fetched by the processor and executed, may provide methods or procedures as described herein.

In yet another embodiment, there may be one or more tangible, nontransitory computer-readable storage media having stored thereon executable instructions that, when executed, cause a hardware platform or other computing system, to carry out a method or procedure. For example, the instructions could be executable object code, including software instructions executable by a processor. The one or more tangible, nontransitory computer-readable storage media could include, by way of illustrative and nonlimiting example, a magnetic media (e.g., hard drive), a flash memory, a ROM, optical media (e.g., CD, DVD, Blu-Ray), nonvolatile random-access memory (NVRAM), nonvolatile memory (NVM) (e.g., Intel 3D Xpoint), or other nontransitory memory.

There are also provided herein certain methods, illustrated for example in flow charts and/or signal flow diagrams. The order or operations disclosed in these methods discloses one illustrative ordering that may be used in some embodiments, but this ordering is not intended to be restrictive, unless expressly stated otherwise. In other embodiments, the operations may be carried out in other logical orders. In general, one operation should be deemed to necessarily precede another only if the first operation provides a result required for the second operation to execute. Furthermore, the sequence of operations itself should be understood to be a nonlimiting example. In appropriate embodiments, some operations may be omitted as unnecessary or undesirable. In the same or in different embodiments, other operations not shown may be included in the method to provide additional results.

In certain embodiments, some of the components illustrated herein may be omitted or consolidated. In a general sense, the arrangements depicted in the FIGURES may be more logical in their representations, whereas a physical architecture may include various permutations, combinations, and/or hybrids of these elements.

With the numerous examples provided herein, interaction may be described in terms of two, three, four, or more electrical components. These descriptions are provided for purposes of clarity and example only. Any of the illustrated components, modules, and elements of the FIGURES may be combined in various configurations, all of which fall within the scope of this specification.

In certain cases, it may be easier to describe one or more functionalities by disclosing only selected elements. Such elements are selected to illustrate specific information to facilitate the description. The inclusion of an element in the FIGURES is not intended to imply that the element must appear in the disclosure, as claimed, and the exclusion of certain elements from the FIGURES is not intended to imply that the element is to be excluded from the disclosure as claimed. Similarly, any methods or flows illustrated herein are provided by way of illustration only. Inclusion or exclusion of operations in such methods or flows should be understood the same as inclusion or exclusion of other elements as described in this paragraph. Where operations are illustrated in a particular order, the order is a nonlimiting example only. Unless expressly specified, the order of operations may be altered to suit a particular embodiment.

Other changes, substitutions, variations, alterations, and modifications will be apparent to those skilled in the art. All such changes, substitutions, variations, alterations, and modifications fall within the scope of this specification.

To aid the United States Patent and Trademark Office (USPTO) and, any readers of any patent or publication flowing from this specification, the Applicant: (a) does not intend any of the appended claims to invoke paragraph (f) of 35 U.S.C. section 112, or its equivalent, as it exists on the date of the filing hereof unless the words “means for” or “steps for” are specifically used in the particular claims; and (b) does not intend, by any statement in the specification, to limit this disclosure in any way that is not otherwise expressly reflected in the appended claims, as originally presented or as amended.

1-57. (canceled)

58. A computer-implemented method of providing content-independent detection of dropped customer service calls to an interactive platform, comprising:
receiving a batch of recorded calls for analysis, the recorded calls comprising recorded audio of customer service calls from a human user to the interactive platform, and call metadata for the recorded calls;
featurizing the recorded calls into per-call feature vectors, comprising extracting features that are independent of content of the recorded calls;
using a machine learning (ML) device to detect dropped calls based on the per-call feature vectors;
providing the dropped calls to a human analyst;
receiving, from the human analyst, a recommendation to improve the interactive platform based on the dropped calls; and
implementing the recommendation on the interactive platform.

59. The computer-implemented method of claim 58, wherein the interactive platform is an interactive voice platform (IVP).

60. The computer-implemented method of claim 58, wherein the call metadata comprise metadata from a telephone carrier.

61. The computer-implemented method of claim 58, wherein featurizing the recorded calls comprises separating the recorded calls into channels.

62. The computer-implemented method of claim 61, wherein the channels comprise a caller channel and a call center channel.

63. The computer-implemented method of claim 61, wherein featurizing the recorded calls further comprises tokenizing the recorded calls into discrete utterances based on per-channel silence.

64. The computer-implemented method of claim 63, wherein featurizing the calls comprises classifying non-speech utterances on only one channel.

65. The computer-implemented method of claim 58, wherein featurizing the recorded calls comprises tokenizing the recorded calls into discrete utterances based on silence.

66. The computer-implemented method of claim 65, wherein featurizing the recorded calls comprises classifying some speech utterances into one or more high-level classes based on content.

67. The computer-implemented method of claim 66, wherein the one or more high-level classes are the only features based on language content.

68. The computer-implemented method of claim 66, wherein the one or more high-level classes comprise an operator greeting.

69. The computer-implemented method of claim 58, further comprising training the ML model on a large set of recorded calls with dropped calls tagged.

70. The computer-implemented method of claim 58, wherein featurizing the recorded calls comprises extracting, from the recorded calls, features channel, termination, uttlen, speechbinary, timedife, eaminsc, and lastagentstime.

71. The computer-implemented method of claim 58, wherein featurizing the recorded calls comprises extracting, from the recorded calls, at least two features selected from a list consisting of channel, termination, uttlen, speechbinary, timedife, eaminsc, lastagentstime, lastagentetime, lastcalleretime, lastcallerstime, ecminsa, scminae, timedifs, timedife, list(range(0,300), timedifs, and samince.

72. The computer-implemented method of claim 71, further comprising excluding, from the list, at least two features that are highly statistically coordinated with one another.

73. One or more tangible, nontransitory computer-readable storage media having stored thereon executable instructions to:
receive a batch of recorded calls for analysis, the recorded calls comprising recorded audio of customer service calls from a human user to an interactive voice platform (IVP), and call metadata for the recorded calls;
featurize the recorded calls into per-call feature vectors, comprising extracting features that are independent of verbal content of the recorded calls;
provide a detection software module to detect dropped calls based on the per-call feature vectors;
provide the dropped calls to a human analyst;
receive, from the human analyst, a recommendation to improve the IVP based on the dropped calls; and
implement the recommendation on the IVP.

74. The one or more tangible, nontransitory computer-readable storage media of claim 73, wherein the detection software module includes a machine learning (ML) routine.

75. A computing apparatus, comprising:
a hardware platform comprising a processor circuit and a memory; and
instructions encoded within the hardware platform to instruct the processor circuit to:
receive a batch of recorded calls for analysis, the recorded calls comprising recorded audio of customer service calls from a human user to an interactive voice platform (IVP), and call metadata for the recorded calls;
featurize the recorded calls into per-call feature vectors, comprising extracting features that are independent of verbal content of the recorded calls;
provide a detection software module to detect dropped calls based on the per-call feature vectors;
provide the dropped calls to a human analyst;
receive, from the human analyst, a recommendation to improve the IVP based on the dropped calls; and
implement the recommendation on the IVP.

76. The computing apparatus of claim 75, further comprising a virtualization infrastructure.

77. The computing apparatus of claim 75, further comprising a containerization infrastructure.
